(19) United States
(12) Patent Application Publication
(10) Pub. No.: US 2017/0195218 A1
(43) Pub. Date: Jul. 6, 2017

(54) ROUTING IN A HYBRID NETWORK

(71) Applicant: QUALCOMM Incorporated, San Diego, CA (US)

(72) Inventors: Sidney Brower Schrum, JR., Ocala, FL (US); Lawrence Winston Yonge, III, Summerfield, FL (US); Richard Ernest Newman, Gainesville, FL (US)

(21) Appl. No.: 14/985,359

(22) Filed: Dec. 30, 2015

(51) Int. Cl. H04L 12/753; H04L 12/721; H04L 12/761; H04L 12/751

(52) U.S. Cl. CPC H04L 45/48; H04L 45/02; H04L 45/12; H04L 45/16

(57) ABSTRACT

A hybrid network may include a mix of different network technologies and devices. A multi-interface device, such as a hybrid device, may provide for bridging of frames between different networks. Some routing schemes may not be suitable for a hybrid network. In this disclosure are various concepts for a routing scheme suitable for a hybrid network. In accordance with a routing scheme, one or more routing trees may be determined based on a topology map for the hybrid network. The topology map may include nodes to represent different interfaces of at least one multi-interface device. A routing tree determined based, at least in part, on the topology map may be used to manage routing of frames in the hybrid network.

### TECHNICAL FIELD

Embodiments of the present subject matter generally relate to the field of network communications, and, more particularly, to routing in a hybrid network.

### BACKGROUND

There are many routing and bridging schemes. Unfortunately, many routing schemes are specific to a particular network technology or topology. For example, Institute of Electrical and Electronics Engineers (IEEE) 802.1aq defines a Shortest Path Bridging (SPB) protocol for Ethernet networks. Other routing protocols may exist for other network technologies. However, a routing scheme designed for one network technology may not be suitable for another network technology. A well-known technique for determining packet routing in traditional router-based network is referred to as Dijkstra's algorithm. Dijkstra's algorithm is designed to determine a shortest path between network nodes in a graph. Dijkstra's algorithm may be acceptable in traditional multi-path point-to-point router networks but may be insufficient for a hybrid network.

### SUMMARY

Various embodiments are described in which one or more routing trees are determined for a hybrid network having a plurality of devices including at least one multi-interface device. A routing tree may be optimized for unicast or broadcast traffic to reach each device in the hybrid network, taking into account capabilities of each interface or communication medium available to each device. In one embodiment, a topology map is determined for the hybrid network. The topology map may include interface-specific nodes for each interface of at least one multi-interface device. A routing tree for the network may be determined based, at least in part, on the topology map. The routing tree may be determined using a modified Dijkstra's algorithm described in this disclosure. Routing of a frame in the network may be managed using the routing tree.

Embodiments of a topology map may include virtual nodes to represent broadcast capabilities available to an interface of a device. Further embodiments describe device-internal nodes to represent devices as target end points for a routing tree for broadcast traffic when more than one interface or path could be used to reach the device. A routing tree for broadcast traffic may be optimized in various embodiments herein. This disclosure also includes embodiments for routing traffic associated with an unknown address. A default common routing tree may be used to flood traffic in a hybrid network. Devices may determine whether to forward or discard frames in accordance to their position in the default common routing tree.

### BRIEF DESCRIPTION OF THE DRAWINGS

The present embodiments may be better understood, and numerous objects, features, and advantages made apparent to those skilled in the art by referencing the accompanying drawings.

FIG. 1 depicts an example of a topology map with an example routing tree to introduce concepts relating to routing trees used throughout this disclosure.

FIG. 2A depicts a hybrid network to introduce concepts related to hybrid networks used throughout this disclosure.

FIG. 2B depicts a topology map corresponding to the hybrid network in FIG. 2A to introduce concepts related to routing used throughout this disclosure.

FIG. 3 depicts an example hybrid network used throughout this disclosure.

FIG. 4 depicts a flow diagram including operations for topology mapping, in accordance with an embodiment of this disclosure.

FIG. 5 depicts a topology map for the example hybrid network of FIG. 3.

FIG. 6 depicts a topology map with different nodes for different interfaces of the example hybrid network of FIG. 3.

FIG. 7 depicts the example hybrid network of FIG. 3 with different physical layer (PHY) rates for various connections in the example hybrid network.

FIG. 8 depicts a topology map for the example hybrid network having link costs associated with the different PHY rates, as described in FIG. 7.

FIG. 9 depicts a first example of a routing tree for unicast traffic, in accordance with an embodiment of this disclosure.

FIG. 10 depicts a second example of a routing tree for unicast traffic, in accordance with an embodiment of this disclosure.

FIG. 11 depicts a topology map for broadcast traffic in the example hybrid network of FIG. 3, in accordance with an embodiment of this disclosure.

FIG. 12 depicts a topology map with a routing tree for broadcast traffic, in accordance with an embodiment of this disclosure.

FIG. 13 depicts a topology map with a routing tree for broadcast traffic using a minimum total cost spanning tree algorithm, in accordance with an embodiment of this disclosure.

FIG. 14 depicts a topology map with a routing tree for broadcast traffic using a modified Dijkstra's algorithm, in accordance with an embodiment of this disclosure.

FIG. 15 depicts a topology map for a hybrid network, and a routing tree for handling traffic associated with a new or unknown network address, in accordance with an embodiment of this disclosure.

FIG. 16 depicts a flow diagram including operations for topology mapping in accordance with an embodiment of this disclosure.

FIG. 17 depicts a flow diagram including operations with modifications to Dijkstra's algorithm in accordance with an embodiment of this disclosure.

FIG. 18 depicts a flow diagram including operations to generate a routing tree for broadcast traffic in accordance with an embodiment of this disclosure.

FIG. 19 is an example block diagram illustrating a device capable of implementing various embodiments of this disclosure.

### DESCRIPTION OF EMBODIMENT(S)

The description that follows includes exemplary systems, methods, techniques, instruction sequences and computer program products that embody techniques of the present subject matter. However, it is understood that the described embodiments may be practiced without these specific details. For instance, some embodiments are described in relation to example hybrid networks that include powerline communications, wireless local area network (WLAN) communications, and Ethernet. In other embodiments, the techniques may be implemented in hybrid networks that include other suitable types of network technologies. Additionally, while some embodiments in this disclosure refer to broadcast communications, those embodiments may also be applicable to multicast communications. In this disclosure, well-known instruction instances, protocols, structures and techniques have not been shown in detail in order not to obfuscate the description.

Embodiments of this disclosure determine topology maps and routing trees suitable for a hybrid network. Embodiments use a topology map to construct one or more routing trees for routing frames in the hybrid network. To aid the reader in understanding the embodiments, this disclosure will begin by describing some networking technologies, devices, and concepts used in connection with the embodiments.

As described above, a hybrid network may include one or more multi-interface devices that may bridge communications between different network technologies. A hybrid network may also be referred to as a Convergent Digital Home Network (CDHN), hybrid home network, or IEEE P1905.1 network. Hybrid networks may exist in home environments, as well as other environments, including workplaces, prisons, schools, etc.

A hybrid network may comprise a mix of hybrid devices and legacy devices. A hybrid device is a device that is configured to use hybrid networking protocols (for example, IEEE P1905.1) that accommodate the use of multi-interface devices in a hybrid network. A hybrid device may be one type of multi-interface device in a hybrid network, and may have multiple interfaces associated with different network technologies (e.g., Ethernet, IEEE 802.11, Coax, and powerline communications (PLC), etc.). A multi-interface hybrid device optionally may be capable of forwarding traffic (bridging) between its interfaces. Legacy devices may be single-interface or multi-interface devices. For example, some legacy devices may also have multiple interfaces and may be configured to bridge traffic between different network segments. However, a legacy device may not be configured to use the hybrid networking protocols. By using the hybrid networking protocols, hybrid devices may communicate with one another and identify multi-interface devices, including multi-interface legacy devices, in the hybrid network. The hybrid network may accommodate different bridging capabilities of a multi-interface device (whether hybrid device or legacy device). For example, hybrid devices may adjust routing in a hybrid network in order to accommodate or manipulate the bridging capabilities of a legacy device.

In accordance with this disclosure, a routing scheme may accommodate routing of traffic in a hybrid network that has at least one multi-interface device. The routing scheme includes gathering and sharing topology information to generate a topology map of the hybrid network. A topology map may be used to maintain information about the devices in a network and the available connectivity between the devices. In accordance with this disclosure, a topology map may also maintain information about the different interfaces of devices in a hybrid network. The topology map may include separate nodes for the different interfaces of a multi-interface device. By representing the interfaces as nodes in the topology map, a routing scheme can generate more complete routing trees based on broadcast and/or unicast routes. For example, the routing trees may include multiple unicast routes from a particular device depending on the forwarding and non-forwarding configurations of other interfaces in the network. For broadcast traffic, the use of separate nodes for each interface allows a routing tree for broadcast traffic to be fully expressed, including showing a selected interface through which a device upper layer will receive a broadcast frame, and which other interfaces should discard broadcast frames in accordance with the routing tree.

Furthermore, the topology map may be defined in a way that predicts and manages the behavior of legacy devices in the hybrid network. In accordance with this disclosure, a topology map may also maintain information about broadcast, multicast, and broadcast-to-unicast paths available for broadcast traffic. The topology map may include virtual nodes for broadcast-related paths in the network. By maintaining information about broadcast paths in the topology map, a routing scheme may accommodate broadcast traffic based on broadcast capabilities of multi-interface devices.

A routing tree may be determined using the topology map. Routing trees indicate routing paths between nodes in topology maps. Routing trees may be different for unicast traffic and for broadcast traffic. A routing tree can accommodate the expected behavior of a legacy device in the hybrid network. Each hybrid device in the hybrid network may determine a same routing tree and use the same routing tree for routing a frame in the hybrid network. The routing tree may include interface-specific nodes (with corresponding source addresses), so that when traffic is routed in the network the correct source address and interface is used.

In some embodiments, the hybrid devices may determine a plurality of routing trees, each routing tree specific to a source interface of a device in the hybrid network. When a frame is received by one of the hybrid devices, an appropriate routing tree is selected based on the source address of the frame matching the source interface for the routing tree. A hybrid device may determine whether to discard or forward the frame depending on whether the interface that received the frame is in the appropriate routing tree for the source of the frame.

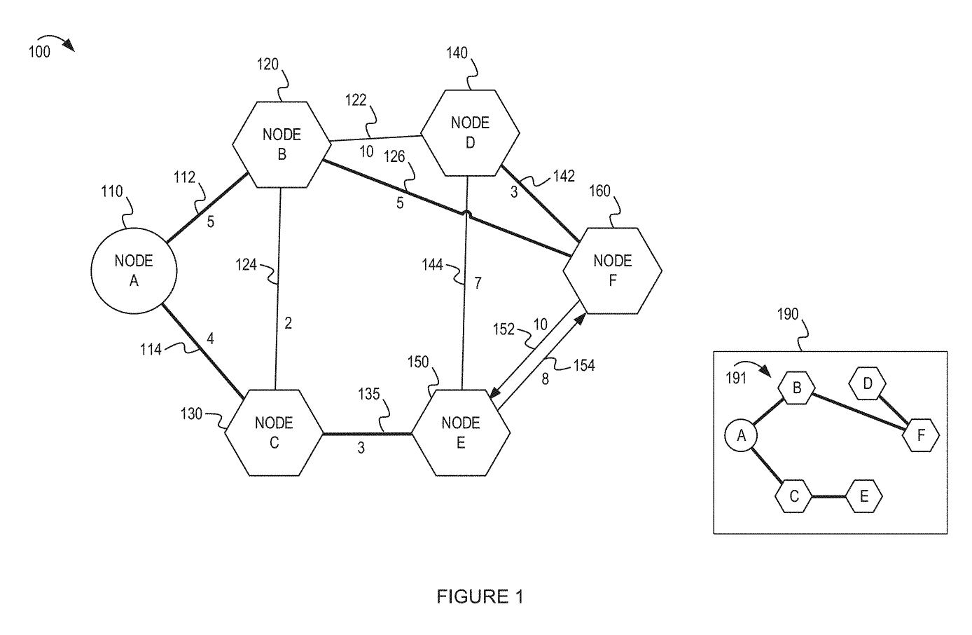

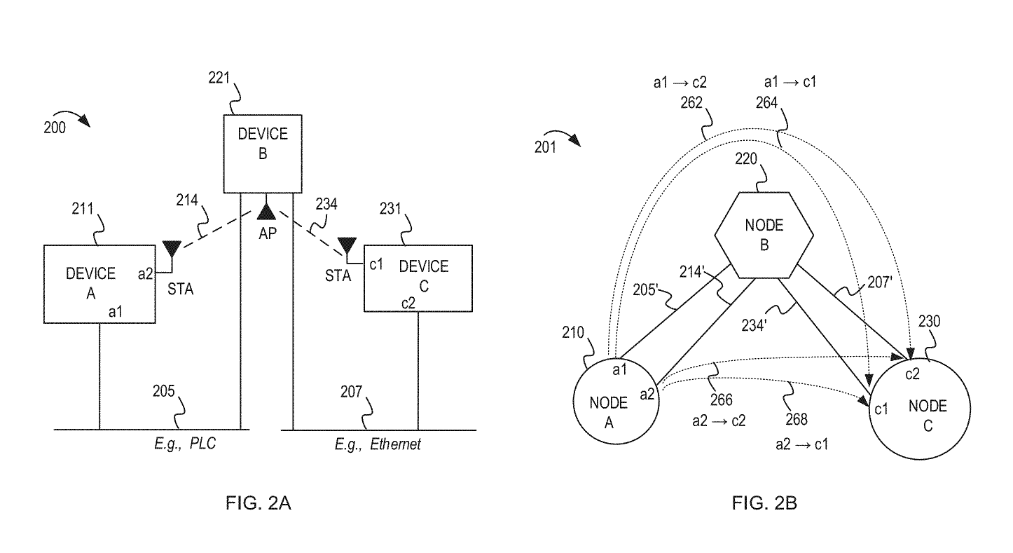

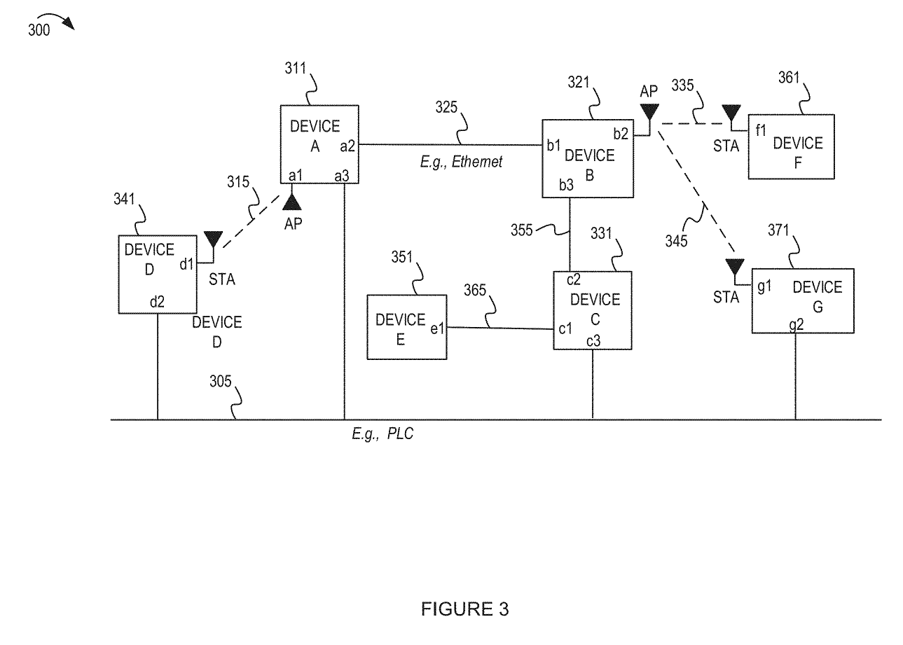

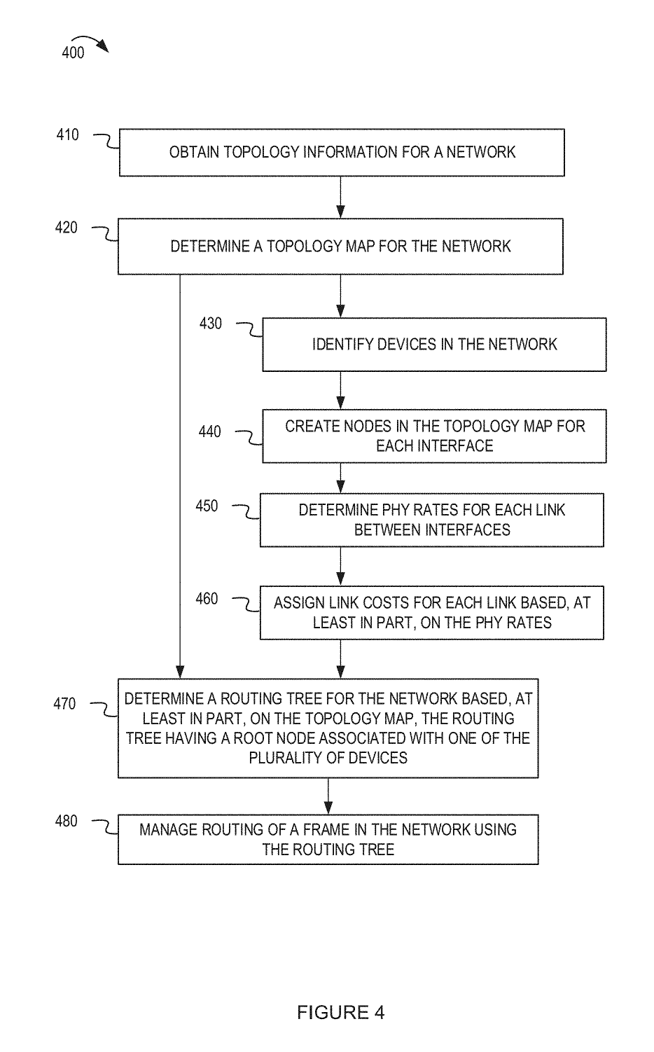

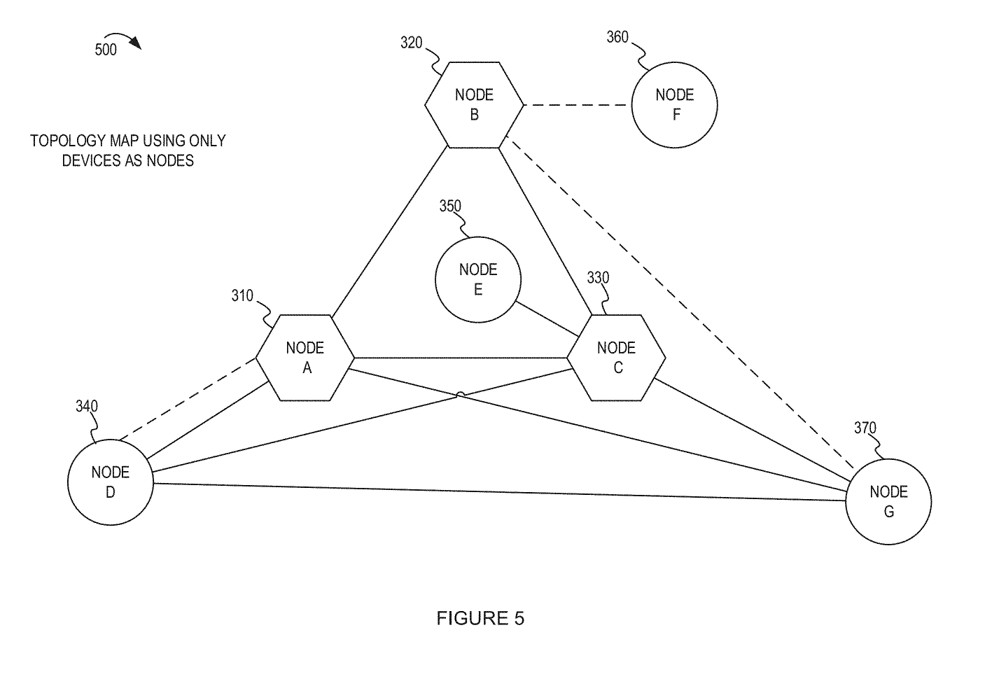

To aid in understanding embodiments of the routing scheme, this disclosure provides several examples. FIGS. 1, 2A, and 2B provide a foundational description of routing schemes, as they may apply to a hybrid network. FIG. 3 describes an example hybrid network which is the basis for several topology maps described in this disclosure. FIG. 4 provides an overview of several operations that may be used to generate a routing tree for a hybrid network. The example hybrid network (from FIG. 3) is the basis for several topology maps and routing trees that are described with reference to FIGS. 5-15.

FIG. 1 illustrates a topology map and routing tree using cost-based graph theory used throughout this disclosure. The topology map 100 is illustrated as a graph, but in computerized implementations, the topology map 100 may also be implemented as a table, database, or other structure in memory. This disclosure includes several topology maps illustrated as graphs merely to aid the human reader in understanding how the topology map relates to a routing tree. In FIG. 1, the topology map 100 has six nodes, including a first node 110 (“node A”), a second node 120 (“node B”), a third node 130 (“node C”), a fourth node 140 (“node D”), a fifth node 150 (“node E”), and a sixth node 160 (“node F”). A node may also be referred to as a vertex in the topology map 100. In FIG. 1, the nodes (or vertices) represent devices in a network. In later figures, the nodes of a topology map may also be used to represent a device interface. However, for simplicity in FIG. 1, each of the nodes 110-160 represent devices. Node A is illustrated as a circle to represent that it is a non-forwarding device. Forwarding and non-forwarding configuration of a device (or interface) become more significant when discussing broadcast traffic and/or bridging capabilities of devices (in later Figures). Nodes B-F are illustrated as hexagons to represent that the devices are capable of forwarding/bridging frames between network segments.

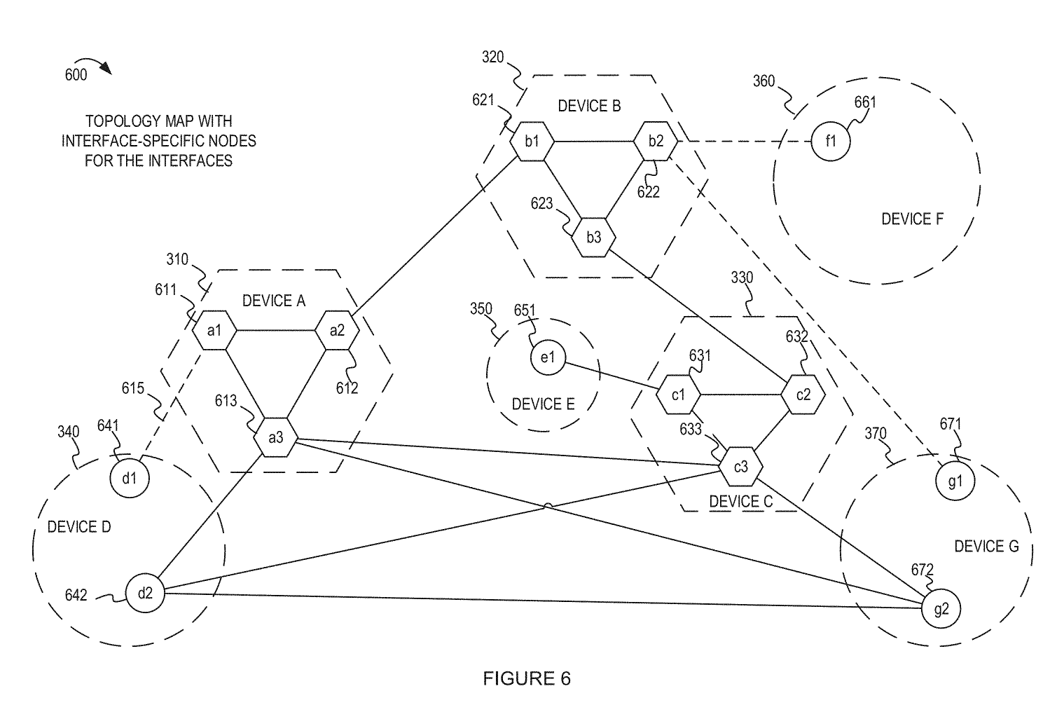

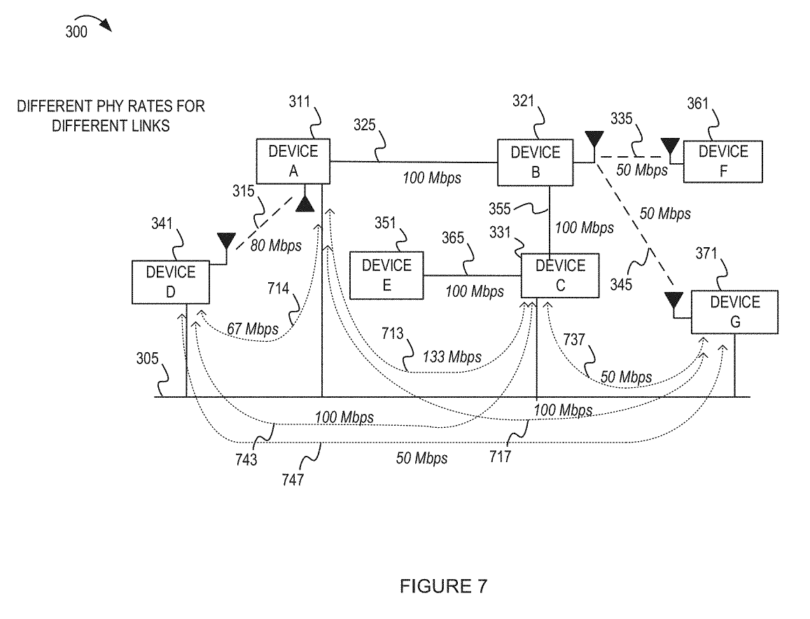

The topology map 100 illustrates, in graph form, the links and link cost between various nodes. A link is represented as a line between the nodes of the topology map. A link cost refers to a measurement which can be used to compare desirability of a link. For example, link costs may be inversely proportional to the link PHY rate and/or available throughput. A higher link cost may represent a lower link PHY rate or lower throughput, while a lower link cost may represent a higher link PHY rate or higher throughput. The link costs in FIG. 1 are provided for illustrative purposes. In some implementations of a graphed topology map, the link cost may also be represented visually using variations in line width or line length. The topology maps, including the lines between nodes, in this disclosure are not drawn to scale or with variation based on link cost. Link costs are further described in FIGS. 6-7. When appropriate, the link costs are included near the link between two nodes. The topology map 100 includes the following example links and link costs:
Link 112 between node A and node B has a link cost of “5.”
Link 114 between node A and node C has a link cost of “4.”
Link 124 between node B and node C has a link cost of “2.”
Link 122 between node B and node D has a link cost of “10.”
Link 126 between node B and node F has a link cost of “5.”
Link 135 between node C and node E has a link cost of “3.”
Link 144 between node D and node E has a link cost of “7.”
Link 142 between node D and node F has a link cost of “3.”
Link 154 from node E to node F has a link cost of “8.”
Link 152 from node F to node E has a link cost of “10.”

Links 152 and 154 are illustrated as arrows (also referred to as directional arcs) to represent a link that is unidirectional. Directional arcs may also be used when a link does not have the same cost in both directions. For example, asymmetric connections between nodes may be illustrated using a pair of directional arcs. Links 112-144 are bidirectional links, meaning that the link cost is the same in both directions.

A path (also referred to as a route) between two nodes may be comprised of one or more links. For example, a path from node A to node E may include link 114 and link 135. A path cost is calculated by summing the link costs for each link in the path. For example, the path cost for the path from node A to node E is “7” (link cost of “4” for link 114, plus link cost of “3” for link 135).

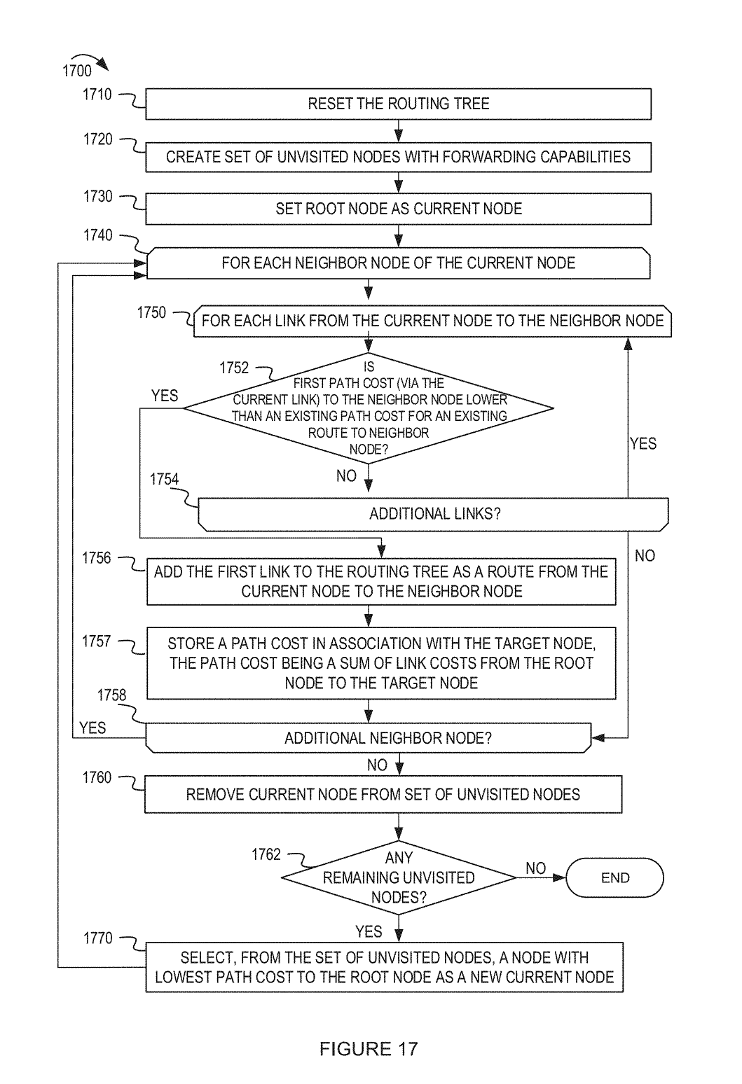

Having described the topology map 100, a concept of an example routing tree will be described. Some embodiments utilize an algorithm (such as a Dijkstra's algorithm or a variation thereof) to generate a routing tree. The example routing tree of FIG. 1 will be generated using Dijkstra's algorithm. More explanation of Dijkstra's algorithm and modifications to support a hybrid network will be described in FIG. 17. A traditional implementation of Dijkstra's algorithm can be summarized as follows:
a. Assign a tentative cost of 0 to a root node (node A for example), and infinity to all other nodes. Mark all nodes as “unvisited.” Mark root node as “current node.”
b. Calculate the path cost from root node through the current node to all other unvisited neighbor nodes. A neighbor node is a node that has a link from the current node. For each unvisited neighbor node, if the path cost to reach the neighbor node is less than the previously assigned tentative cost, update assigned tentative cost.
c. Mark current node as visited. Choose an unvisited node with the lowest tentative cost as the new current node.
d. Repeat steps b and c until all nodes have been visited or there are no more links from visited nodes to unvisited nodes.

Having described Dijkstra's algorithm, the example routing tree will be described. The example routing begins with node A as the root node. From node A, Dijkstra's algorithm determines a path to node B via link 112. After visiting node C, Dijkstra's algorithm may also initially determine a path from node A to node D via node B. For example, the path may include link 112 to node B and then link 122 to node D. The path cost would be “15” (link cost of “5” for link 112, plus link cost of “10” for link 122). However, Dijkstra's algorithm may replace this initially-determined path from node A to node D via node B, once a lower cost path is determined. For example, the lower cost path from node A to node D may include the link 112 to node B, then link 126 to node F, then link 142 to node D. The path cost would be “13” (link cost of “5” for link 112, plus link cost of “5” for link 126, plus link cost of “3” for link 142). Because the new path (via node B and node F) has a lower cost (path cost of “13”) than the previous path (via only node B, having a path cost of “15”), the new path will be selected and the previous path will be discarded.

In the topology map, links 112 and 114 are shown with a higher line weight to represent that those links remain part of the routing tree. Continuing through the algorithm, the remaining portions of the routing tree will be determined. The inset 190 shows the resulting routing tree 191 without the unused links. The unused links remain present in the network and in the topology map, but may not be used in the routing tree 191 until a failure, congestion, link cost update, or some other stimulus causes the routing tree to be recalculated.

Since the routing tree 191 is specific to node A as the root node, the routing tree 191 shows the lowest cost routes from node A to each of the other nodes. For a communication from node A to node E, the node A would send a frame via link 114 to node C, and would expect node C to forward the frame to node E via link 135. For a communication directed from node A to node D, the node A would send the frame via link 112 to node B, and would expect the frame to follow the route defined by the routing tree to reach node D. The route is defined as link 112 to node B, then link 126 to node F, then link 142 to node D. This route has a path cost of “13” (sum of link costs “5,” “5”, and “3” for links 112, 126, and 142, respectively). This is a lower path cost than an alternative route that includes link 122.

The example in FIG. 1 is considered a multi-path point-to-point topology map. The topology map 100 may be insufficient to account for complexities associated with a hybrid network. For example, a hybrid network may use a shared medium between a plurality of nodes. One or more of the devices in the hybrid network may be configured to bridge traffic from one network segment to another network segment, which may result in duplicate frames received on different interfaces of a multi-interface device.

FIG. 2A depicts a hybrid network having multi-interface devices. The hybrid network 200 includes a first device 211 (“device A”), a second device 221 (“device B”), and a third device 231 (“device C”). In the example of FIG. 2A, the first device 211, second device 221, and third device 231 are hybrid devices.

Device A has two interfaces, labeled “a1” and “a2.” Interface “a1” couples device A to a first network 205 (e.g., a PLC network). Device A can communicate with device B via the first network 205. Interface “a2” is configured as an IEEE 802.11 wireless client station (STA) and couples device A to an IEEE 802.11 access point (AP) at device B. The wireless connection 214 (shown as a dashed line) represents a communication path from interface “a2” to the AP at device B.

Device C also has two interfaces, labeled “c1” and “c2.” Interface “c1” is configured as an IEEE 802.11 STA and couples device C to the AP at device B. The wireless connection 234 (shown as a dashed line) represents a communication path from interface “c2” to the AP at device B. Interface “c1” couples device C to a second network 207. The second network 207 may use a different network technology than first network 205. For example, second network 207 may be an Ethernet network. Device C can communicate with device B via the second network 207.

Because there is a plurality of interconnections in the hybrid network 200, there may be many paths from device A to device C. FIG. 2B shows a topology map corresponding to the hybrid network 200, and showing the various paths available.

FIG. 2B depicts a topology map associated with the hybrid network of FIG. 2A. The topology map 201 represents each device as a node without regard to the interfaces at each device, and illustrates a problem with traditional topology maps that do not represent each interface as a separate node. The topology map 201 includes a first node 210 (“node A”) associated with first device 211 (device A) of FIG. 2A, a second node 220 (“node B”) associated with second device 221 (device B) of FIG. 2A, and a third node 230 (“node C”) associated with third device 231 (device C) of FIG. 2A. Lines 205′, 207′, 214′ and 234′ in the topology map 201 are shown to illustrate the potential connections via first network 205, second network 207, and wireless connections 214, 234, respectively. Some traditional topology maps may only represent one line between the device nodes without regard to the number or variety of connections available between the device nodes.

FIG. 2B illustrates one of the challenges associated with using some topology maps and routing schemes with a hybrid network. One of the goals of hybrid networking is to exploit multiple paths for delivery of frames between devices, in order to increase throughput, perform “load balancing,” or otherwise improve quality of service. However, if a topology map does not properly include information regarding available paths and interfaces for delivery of frames, the topology map may produce an inaccurate or less efficient routing tree for the hybrid network. In other words, a topology map that does not maintain information about various interfaces and bridging relationships in the hybrid network may limit or hinder proper route selection.

Assuming that device B is configured to bridge all traffic from all interfaces, there may be a variety of paths between node A and node C. Focusing only on potential traffic from node A to node C, FIG. 2B depicts potential paths that are available for node A to transmit a frame to node C. In the simple example in FIG. 2B, there are 4 possible paths between device A and C. Each path may be identified by a source interface and destination interface. The paths are:
first path 262 from interface “a1” of device A via first network 205 to device B, then via second network 207 to interface “c2” of node C.
first path 264 from interface “a1” of device A via first network 205 to device B, then via wireless connection 234 to interface “c1” of node C.
first path 266 from interface “a2” of device A via wireless connection 214 to device B, then via second network 207 to interface “c2” of node C.
first path 268 from interface “a2” of device A via wireless connection 214 to device B, then via wireless connection 234 to interface “c1” of node C.

As described above, the routing scheme may not identify all of these paths. If multi-interface devices are shown using a single node, consistent with a conventional approach (and as shown in FIG. 2B), a conventional application of topology graphs and Dijkstra's algorithm would result in generation of only a single, optimal path.

The simple example in FIG. 2B only shows a small topology with three devices. However, as more multi-interface devices and topologies are introduced into the network, the routing schemes should accommodate a variety of multi-interface devices and networks. For example, some multi-interface devices in the hybrid network may not support forwarding on a particular interface due to network configuration or manufacturer design. By eliminating support for forwarding on one or more interfaces, a manufacturer may reduce the cost, development time, and support associated with a multi-interface device. When such multi-interface devices are in the hybrid network, improvements to the routing schemes may be beneficial. For example, in accordance with embodiments of this disclosure, a topology map includes separate nodes for separate interfaces of each device. The forwarding/bridging capabilities may also be represented in the topology map using links between interface-specific nodes.

FIG. 3 depicts an example hybrid network. FIG. 3 corresponds to topology maps in FIGS. 4 and 6-15, and is used in the description of various embodiments throughout this disclosure. The example hybrid network 300 includes a first device 311 (“device A”), a second device 321 (“device B”), a third device 331 (“device C”), a fourth device 341 (“device D”), a fifth device 351 (“device E”), a sixth device 361 (“device F”), and a seventh device 371 (“device G”).

Device A has multiple interfaces, labeled “a1,” “a2,” and “a3.” Interface “a1” represents an AP for an IEEE 802.11 WLAN and has a wireless connection 315 to an IEEE 802.11 STA at interface “d1” of device D. Interface “a2” is coupled using a wireline connection 325 (e.g., Ethernet) to interface “b1” of device B. Interface “a3” is coupled to a first network 305 (e.g., a PLC network).

Device B has multiple interfaces, labeled “b1,” “b2,” and “b3.” Interface “b1” is coupled using the wireline connection 325 (e.g., Ethernet) to interface “a2” of device A. Interface “b2” represents an IEEE 802.11 AP for a WLAN and has wireless connections 335, 345 to devices F, G, respectively. Interface “b3” is coupled via a wireline connection 355 to interface “c2” of device C.

Device C has multiple interfaces, labeled “c1,” “c2,” and “c3.” Interface “c1” is coupled using a wireline connection 365 (e.g., Ethernet) to interface “e1” of device E. Interface “c2” is coupled using the wireline connection 355 to interface “b3” of device B. Interface “c3” is coupled to the first network 305.

Device D has multiple interfaces, labeled “d1,” and “d2.” Interface “d1” is coupled using the wireless connection 315 to the AP at interface “a1” of device A. Interface “d2” is coupled to the first network 305. Device E is a legacy device with only one interface, labeled “e1.” Interface “e1” is coupled via the wireline connection 365 to interface “c1” of device C. Device F is a legacy device with only one interface, labeled “f1.” Interface “f1” is coupled via the wireless connection 335 to the AP at interface “b2” of device B. Device G has multiple interfaces, labeled “g1,” and “g2.” Interface “g1” is coupled using the wireless connection 345 to the AP at interface “b2” of device B. Interface “g2” is coupled to the first network 305.

Even though device D and device G both have multiple interfaces, they may be legacy devices or hybrid devices. Regardless of whether they are hybrid devices or legacy devices, in the example hybrid network 300, device D and device G are configured not to bridge traffic between their WLAN connection and their connection to first network 305. This may be due to manufacturer design choice, device limitation, user configuration, device configuration, or system restraints. For example, because interfaces “d1” and “g1” are wireless client stations for their respective WLANs, the devices may not bridge the traffic from those interfaces to the first network 305.

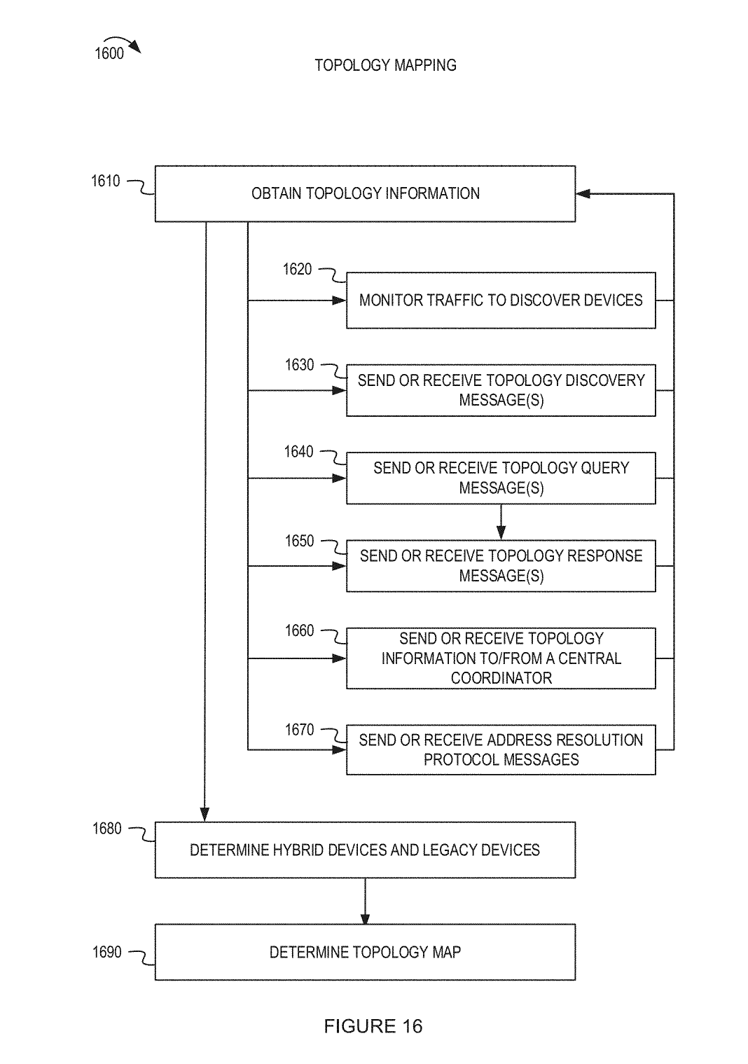

FIG. 4 depicts a flow diagram including operations for a routing scheme, in accordance with an embodiment of this disclosure. The flow 400 begins at block 410. At block 410, a device obtains topology information for a network. Several operations for obtaining topology information are described at FIG. 16.

At block 420, the device determines a topology map for the network. There may be many different implementations for determining a topology map. For example, the device may receive the topology map from a central coordinator in the network. Alternatively, the device may perform several operations and refinement to determine the topology map. In one implementation, a device may query some or all of the other devices in the network to gain the information needed to develop the topology map.

The operations at blocks 430-460 represent one example of developing the topology map. At block 430, the device identifies devices in the network. At block 440, the device creates nodes in the topology map for each interface of various devices in the network. At block 450, the device determines physical layer (PHY) rates for each link between the interfaces. At block 460, the device assigns link costs for each link based, at least in part, on the PHY rates.

At block 470, the device determines a routing tree for the network based, at least in part, on the topology map. The routing tree has a root node associated with one of the plurality of devices in the network. At block 480, the device manages routing of a frame in the network using the routing tree.

FIG. 5 depicts a topology map for the example hybrid network of FIG. 3. The topology map 500 is an example of a topology map in which each device is represented by a single node. Forwarding nodes are depicted as hexagons, while non-forwarding nodes are depicted as circles. Topology map 500 includes the following nodes:
a first node 310 (“node A”) associated with first device 311 (device A) of FIG. 3,
a second node 320 (“node B”) associated with second device 321 (device B) of FIG. 3,
a third node 330 (“node C”) associated with third device 331 (device C) of FIG. 3,
a fourth node 340 (“node D”) associated with fourth device 341 (device D) of FIG. 3,
a fifth node 350 (“node E”) associated with fifth device 351 (device E) of FIG. 3,
a sixth node 360 (“node F”) associated with sixth device 361 (device F) of FIG. 3, and
a seventh node 370 (“node G”) associated with seventh device 371 (device G) of FIG. 3.

As described above, the topology map 500 may maintain only one node per device. Thus, the topology map 500 may not maintain information about the forwarding/bridging capability for each interface of a multi-interface device. If a routing algorithm is run using the topology map 500, the resulting routing tree may not be properly optimized in view of the different interface configurations and forwarding configuration of the interfaces.

A topology map that accommodates multi-interface devices may be configured to maintain for more accurate information about the forwarding/non-forwarding configuration of individual interfaces at each device. The topology map may maintain link costs for links between devices based on which interface of the devices is being used. One way to accomplish this is to represent the interfaces of each device as separate interface-specific nodes in the topology map.

FIG. 6 depicts a topology map with different nodes for different interfaces of the example hybrid network of FIG. 3, in accordance with an embodiment of this disclosure. The topology map 600 is described in relation to the topology map 500 of FIG. 5, and the interface labels described in FIG. 3. However, in topology map 600, each device (shown by dotted shape) can be represented in the topology map as a set or collection of associated interface-specific nodes, one node for each interface of the device.

In one embodiment, the topology map utilizes the media access control (MAC) address of each interface to identify the node, rather than using a network layer address (such as an Internet Protocol, IP, address) or other identifier. Using the topology map 600, a multi-interface device can support multiple paths from itself (via various interfaces) to another device in the network. For example, because each interface is represented as a separate node, a unique routing tree can be calculated for each interface. In one embodiment, a device originating a frame may select among different routes by selectively transmitting the frame via a source interface associated with the selected route. A source MAC address of the frame may be updated to reflect the MAC address of the source interface.

Device A (previously represented as first node 310 in FIG. 5) comprises with nodes 611, 612, 613 representing interface-specific nodes associated with interfaces “a1,” “a2,” and “a3,” respectively. Each of the interfaces “a1,” “a2,” and “a3” of device A are forwarding/bridging interfaces. Therefore, the topology map 600 includes links joining the nodes 611, 612, 613. Having created separate nodes in the topology map 600 for each interface of device A, it is now possible to draw the topology map with links at particular interfaces. For example, the wireless connection 315 between interface “a1” of device A and interface “d1” of device D may be represented by a link 615 between node 611 and node 641, which represents the wireless client interface “d1” of device D. For brevity, the descriptions of remaining links between each node in topology map 600 are omitted, but will be further described when describing the routing trees.

Device B (previously represented as second node 320 in FIG. 5) comprises nodes 621, 622, 623. Device C (previously represented as third node 330 in FIG. 5) comprises nodes 631, 632, 633. Device D (previously represented as fourth node 340) comprises nodes 641, 642. Since device D is configured as an end device (non-forwarding) there is no path representing a bridge between node 641 and node 642.

Device E (previously represented as fifth node 350 in FIG. 5) comprises only one node, node 651. Even though device E is not a multi-interface device, the topology map may still create an interface-specific node to represent the single interface of device E. Similarly, Device F (previously represented as sixth node 360 in FIG. 5) comprises node 661 to represent the single interface of device F.

Device G is similar to device D, in that it has multiple interfaces without bridging enabled between the interfaces. The seventh node 370 is replaced with nodes 671, 672 to represent the interfaces “g1” and “g2,” respectively, of device G.

In addition to representing links between nodes, the topology map may store link costs associated with the links. In one embodiment, the link costs are associated with a PHY rate (also referred to as a physical layer transmission rate) between devices. When sharing topology information, a first hybrid device may also inform a second device about an effective PHY rate from itself to other devices reachable by an interface of the first hybrid device. The effective PHY rate may be based on the communication medium, configuration settings, network conditions, etc.

FIG. 7 depicts the example hybrid network of FIG. 3 with different PHY rates for various connections in the example hybrid network. Reference numerals in FIG. 7 have the same meaning as described with regard to FIG. 3. Different from FIG. 3, FIG. 7 also includes the PHY rates for various connections between pairs of devices. Because the PHY rates may be specific for a connection between a pair of devices, the PHY rate may describe a “link” between the pair of devices. As described previously, the link is represented on a topology map as a line between the nodes representing those devices. PHY rates may be determined for each link using a variety of mechanisms. For example, each device may send topology messages to other devices to indicate the PHY rates measured by each device. For example, hybrid devices may exchange link state announcement (LSA) messages describing the PHY rates for links from a hybrid device to other devices. The LSA messages may include a list of neighbor devices discovered by the hybrid device, and the effective PHY rate to each neighbor device. A neighbor device is a device that is determined to be coupled via a connection that doesn't traverse a forwarding/bridging device. For example, a neighbor device may be directly connected via a communication medium.

In FIG. 7, the wireless connection 315 has a PHY rate of 80 Mbps. The wireline connection 325, wireline connection 355, and wireline connection 365 may each have a PHY rate of 100 Mbps. The wireless connection 335 and wireless connection 345 have a PHY rate of 50 Mbps. Notice that the PHY rate for wireless connection 315 and wireless connection 335 are different. This may be because of different types of WLAN technology (e.g., 2.4 GHz, 5 GHz, dual antenna, etc.), configuration of the APs, channel variations, optimization protocols, network conditions, etc. In some implementations, a wireline or wireless connection may selectively support more than one PHY rate. For example, a device may selectively operate a wireless link using either 2.4 GHz or 5 GHz wireless PHY rate. In that case, the example hybrid network could include two wireless connections and/or two wireless interfaces to represent the two options. For simplicity in FIG. 7, the example hybrid network is shown with only one PHY rate for each connection between devices.

For the first network 305, the effective PHY rate may vary for particular pairs of devices that communicate via the first network 305. For example, in a PLC network, the effective PHY rate may depend on the quality of the channel between pairs of devices due to channel attenuation, line noise, etc., and may be different depending on the endpoints of the communication in the PLC network. In FIG. 7, a communication between device A and device D via the first network 305 may have a PHY rate 714 of 67 Mbps. A communication between device A and device C via the first network 305 may have a PHY rate 713 of 133 Mbps. A communication between device A and device G via the first network 305 may have a PHY rate 717 of 100 Mbps. A communication between device C and device D via the first network 305 may have a PHY rate 743 of 100 Mbps. A communication between device C and device G via the first network 305 may have a PHY rate 737 of 50 Mbps. A communication between device D and device G via the first network 305 may have a PHY rate 747 of 50 Mbps.

The PHY rates may be used to assign link costs to links in the topology map. So that a routing tree can be determined from the topology map, the PHY rates for each link may be normalized or adjusted to account for different network technologies. In one embodiment, the link costs are derived based, at least in part, on the PHY rates. For illustrative purposes only, in this disclosure the link costs are determined by dividing a common numerator by the PHY rates. For example, a number 2000 divided by a PHY rate of 100 Mbps results in a link cost of “20.” This example formula is only one example of deriving a link cost based on the PHY rates.

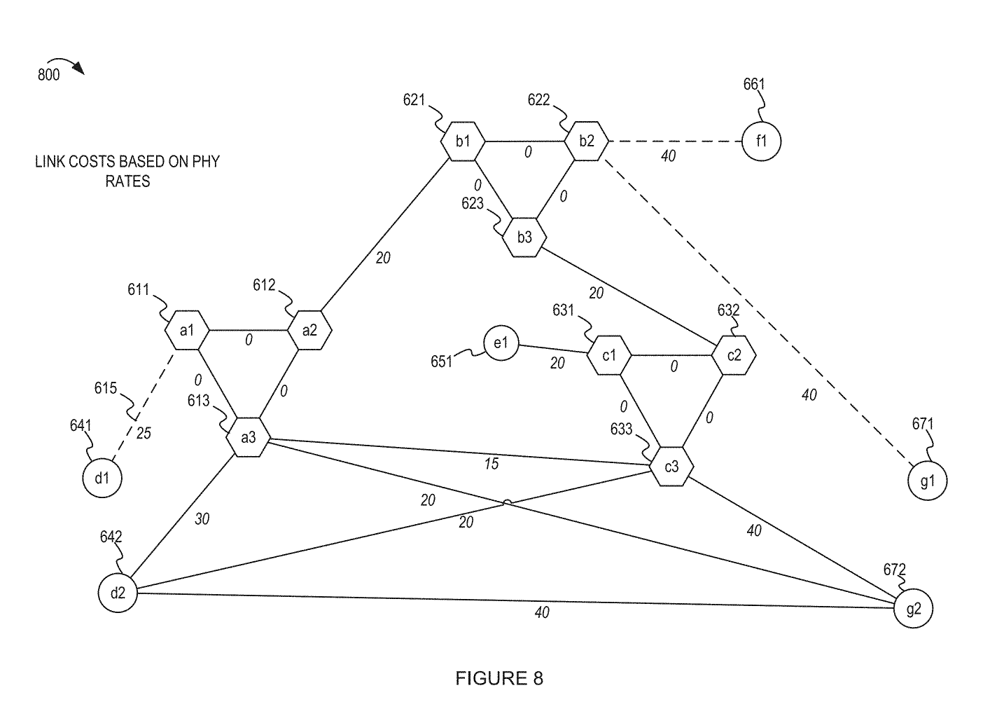

FIG. 8 depicts a topology map for the example hybrid network having link costs associated with the different PHY rates, as described in FIG. 7. Reference numerals in FIG. 8 have the same meaning as described with regard to FIG. 6. The topology map indicates the link costs for each link. For example the link 615 (representing the wireless connection 315 of FIG. 7) between node 611 and node 641 has a PHY rate of 80 Mbps. Using the standard formula of 2000 divided by the PHY rate, the link cost of “25” is determined. For links between bridging interfaces in the same device, the link cost may be negligible, and may represented by a nominal value, such as zero. In FIG. 8, the links between bridging interfaces is designated as “0.” After translating the PHY rates to corresponding link costs the topology map 800 may be updated to include the link costs. The link costs may be used in determining one or more routing trees.

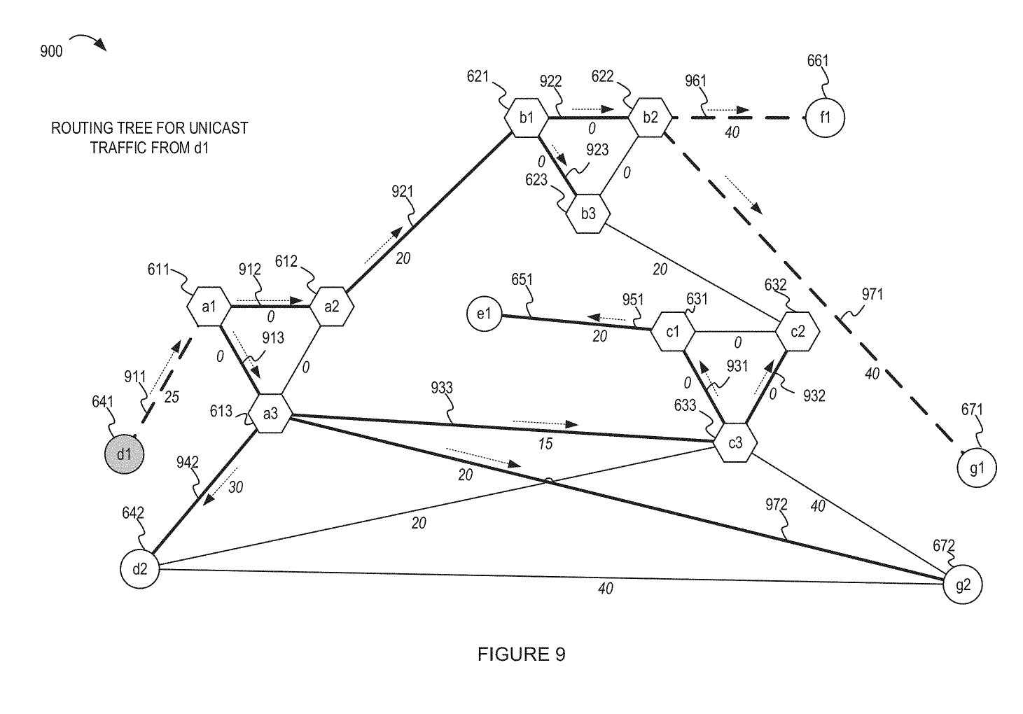

FIG. 9 depicts a first example of a routing tree for unicast traffic, in accordance with an embodiment of this disclosure. In FIG. 9, the topology map is identical to the topology map 800. The routing tree is represented by heavier lines in the topology map 900. That is, the links between nodes that are used in the routing tree are drawn with the heavier lines to show the selected links in association with the topology map 900. The following discussion will explain how some embodiments build the routing tree.

In the example of FIG. 9, the node 641 (representing interface “d1” of device D) is designated as the root node for the routing tree. The routing tree illustrated in FIG. 9 would be appropriate for traffic sourced from interface “d1” to one of the other nodes in the network. Since each node represents an interface, the routing tree can be used to determine a route from “d1” to any other interface reachable in the network. Each device in the network may determine the same routing tree associated with node 641 as the root node. In one embodiment, each device is aware of the full topology map and generates routing trees for different nodes as the root node. When a frame is received at an interface, each device may manage forwarding of the frame based on the routing tree associated with the source interface and intended destinations (which are identified based on the MAC source address and MAC destination address in the frame respectively).

The routing tree begins from node 641 and traverses link 911 to node 611. From node 611, the routing tree extends to nodes 612, 613 in the same device. Therefore, if device D (see FIG. 7) has traffic to send from interface “d1” to device A (see FIG. 7), the route that it would use is via link 911 to interface “a1.” The device A (see FIG. 7) may then process the frame. If device D transmits a frame from interface “d1” to interface “a1” of device A, and the frame is not addressed to device A, then device A may forward/bridge the frame from interface “a1” to either interface “a2” or “a3” depending on the destination address and the routing tree.

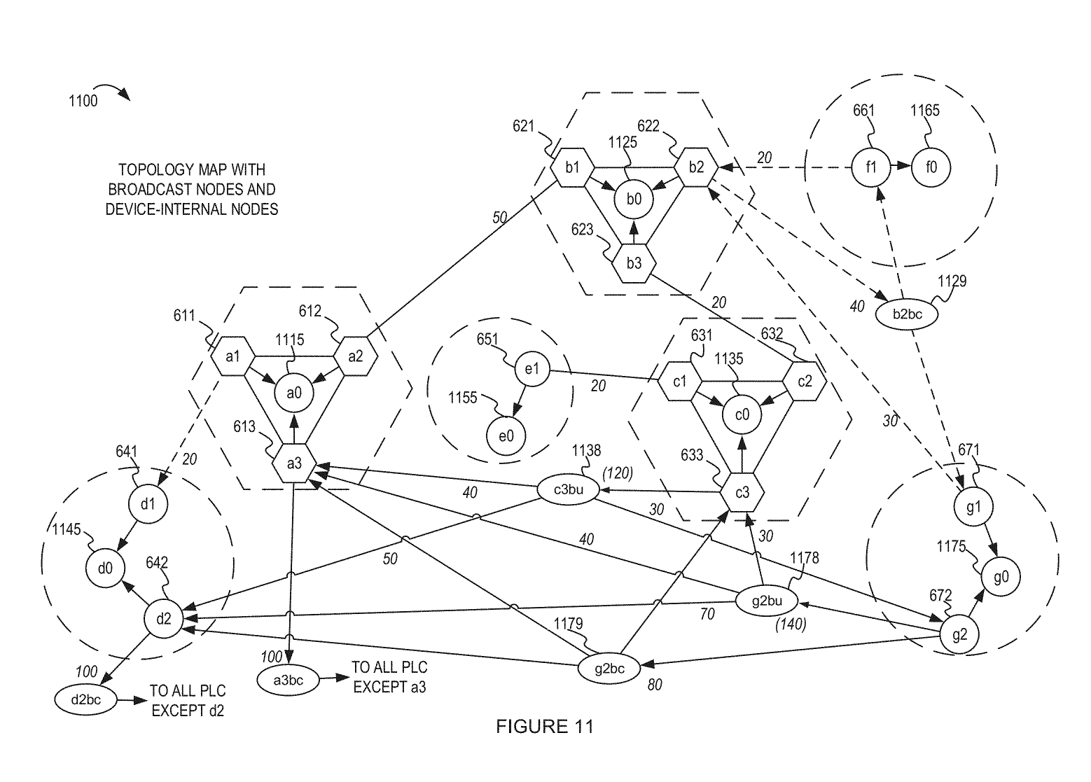

Thus, using the routing tree, device D may determine which route will be used to send a frame from node 641 to any other reachable node in the topology map 900. Similarly, when a device receives a frame via an interface that is not in the routing tree, the device may discard the frame. This may occur, for example, because of legacy bridging devices that are configured to bridge frames between different interfaces of the legacy device. Legacy devices typically are not aware of routing trees generated and used by hybrid devices and they may not forward frames consistent with these routing trees. Hybrid devices in the network may discover a legacy bridging device, and may adjust the topology map to reflect the behavior of the legacy bridging device. The adjusted topology map may be used to determine a routing tree that is consistent with the behavior of the legacy bridging device. A device may also discard a broadcast frame when it is received via an interface that is not in the routing tree. For example, a broadcast frame received on a shared network segment may be a duplicate of another frame received through a different interface that is in the routing tree. The device may discard one of the frames to avoid processing multiple copies and to prevent broadcast loops. The determination of which frame to discard may be based on the routing tree. Broadcast routing is described in more detail in FIGS. 11-15.

The routing tree in FIG. 9 may be determined using an algorithm, such as Dijkstra's algorithm or a modified Dijkstra's algorithm. For example, starting from node 641, as the root node, the link costs are calculated for neighbor nodes. Only node 611 is a neighbor to node 641, because there are no other links from node 641 to another node. The route to node 611 is added to the routing tree. Then from node 611, the lowest cost links are for links 912 and 913 to nodes 612 and 613, respectively. Next, the algorithm may select one of the nodes 612 and 613 as the current node, and continues iteratively finding the lowest link cost to neighbor nodes. Then, the algorithm may select a new node as the current node.

The resulting routing tree from node 641 includes links 911, 912, 913, 921, 922, 961, 971, 923, 932, 933, 931, 951, 942, and 972. Pertinent to this disclosure, there are two routes from node 641 which can reach device G (either node 671 or node 672). When device D has traffic for device G, it may consider different routes available in the routing tree. For example, a first route traverses link 911 to node 611, link 912 to node 612, link 921 to node 621, link 922 to node 622, and then link 971 to node 671 (representing interface “g1” of device G). The path cost for the first route is “85” (sum of link costs 25, 0, 20, 0, and 40). A second route traverses link 911 to node 611, link 913 to node 613, link 972 to node 672 (representing interface “g2” of device G). The path cost for the second route is “45” (sum of link costs 25, 0, and 20). Based on the routing tree, the device D may select the least cost path (the latter path) to reach device G.

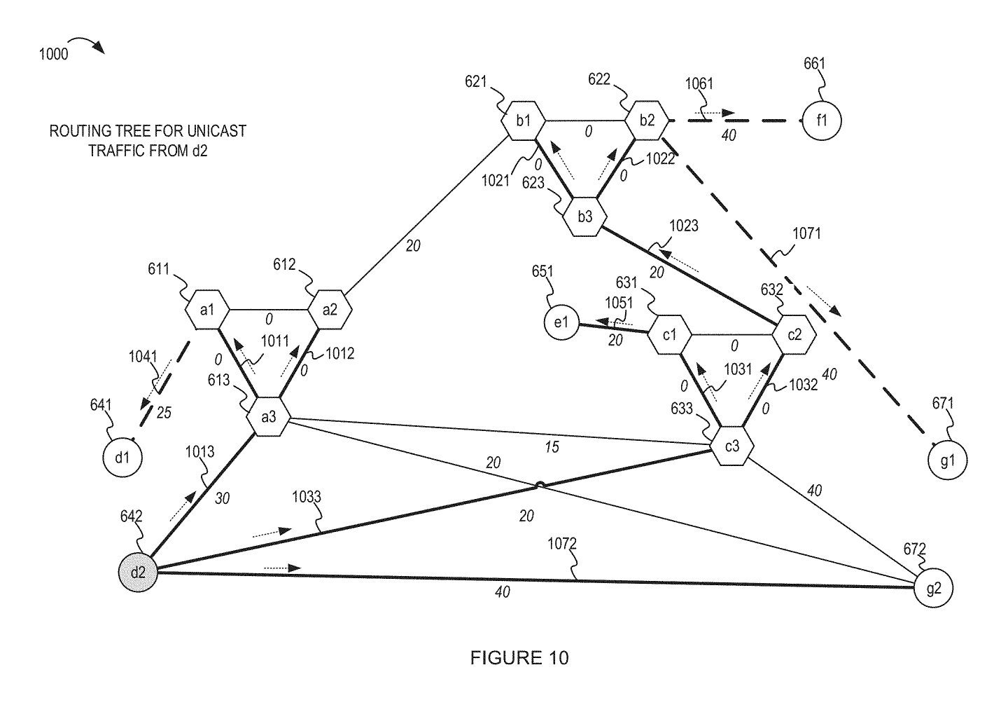

FIG. 10 depicts a second example of a routing tree for unicast traffic, in accordance with an embodiment of this disclosure. FIG. 10 shows the routing tree for unicast traffic from node 642 (representing interface “d2” of device D). Following the routing tree, device D may determine which route will be used to send a frame from node 642 to any other reachable node in the topology map 1000.

The routing tree in FIG. 10 from node 642 includes links 1013, 1033, 1072, 1011, 1041, 1012, 1021, 1031, 1032, 1051, 1023, 1022, 1061, and 1071. Pertinent to this disclosure, there are two routes from node 642 which can reach device G (either node 671 or node 672). A first route traverses link 1033 to node 633, link 1032 to node 632, link 1023 to node 623, link 1022 to node 622, and then link 1071 to node 671. The path cost of the first route is “80” (sum of link costs 20, 0, 20, 0, and 40). A second route traverses link 1072 to node 672. The path cost of the second route is “40” (link cost of 40 for the only link in the route).

Considering both FIGS. 9 and 10 together, there may be a total of four routes from device D (either source interface “d1” or “d2”) to reach device G (either destination interface “g1” or “g2”). In one embodiment of this disclosure, a source device selects a source interface and a destination interface based on a least cost route from among of plurality of routes between devices. For example, the device D may select a route from node 642 to node 672 (“d2” to “g2”) after determining the selected route has a lower path cost than other routes to either “g1” or “g2.” This may be referred to as “least cost tree routing.” Before transmitting the MAC frame from the source interface, the source device may overwrite the source and destination MAC addresses in a MAC frame to correspond to source interface and destination interface of the selected route. Doing so will cause other devices in the network to select the same route for the MAC frame as intended by the source device. In one embodiment, a device may not always utilize a least-cost route, or even just one route. Multiple routes may be used in order to obtain greater throughput and improved quality of service when congestion occurs.

Least cost tree routing need not be limited to unicast routes. In some embodiments, a routing tree for broadcast traffic is determined. A topology map may be modified to accommodate different link costs and broadcast paths associated with broadcast transmissions. In the context of a hybrid network, the topology map and algorithm may accommodate generation of a routing tree for broadcast traffic that is optimized for the hybrid network. For example, a traditional routing tree algorithm (such as IEEE 802.1D, Spanning Tree Protocol) may only consider forwarding devices (bridges or routers), assuming that every target end device is guaranteed to be reached when the forwarding devices transmit a broadcast frame onto a network segment, and because the target end devices are presumed to support only a single interface. However, this approach is unsuitable with some hybrid networking technologies because not every device is guaranteed to obtain a copy, and because one of the objectives of a hybrid network is to enable multiple paths through the hybrid network to improve throughput and quality of service. However, because of the complexities of a hybrid network traditional spanning tree protocols may not result in an optimal routing tree for broadcast traffic. Furthermore, a routing tree optimized for broadcast traffic may be different from a routing tree used for unicast traffic, as described above. FIGS. 11-14 and 18 describe embodiments associated with routing trees for broadcast traffic.

FIG. 11 depicts a topology map for broadcast traffic, in accordance with an embodiment of this disclosure. Hybrid networks can present challenges when developing a routing tree for broadcast traffic. When developing a routing tree for broadcast traffic, the goal is to route the broadcast traffic to each device regardless of which interface on the device is used to reach the device. As described in the previous Figures, a topology map may use interface-specific nodes to represent different interfaces. Rather than generate a routing tree to reach each interface-specific node, the goal for broadcast traffic is to reach each device using at least one interface-specific node. In FIG. 11, additional nodes (sometimes referred to as “device-internal” nodes) can represent each device in the network. The device-internal nodes can be used in the routing tree as endpoints for a communication directed at the device.

Relationships between the interface-specific nodes and device-internal nodes can be illustrated based on the direction of traffic. For example, in FIG. 11, the links to the device-internal nodes are shown as directed toward the device-internal node for incoming broadcast traffic. However, the links to the device-internal nodes may be reversed to indicate outgoing transmissions, such as when the device is the source of a broadcast/multicast message. In one implementation, the links adjacent to a particular device-internal node will either be directed away from or to the device-internal node, depending on whether that device-internal node is a source (originator) or a destination (sink) of traffic, respectively. Even when the links adjacent to device-internal nodes are depicted as unidirectional links, the links between interface nodes may be independently depicted as unidirectional, bidirectional, or non-existent. In this way, the topology map can maintain information about which interface-specific nodes of a multi-interface device are configured to forward (e.g., bridge) traffic to another interface-specific node. In one embodiment, there may be a single broadcast graph for a hybrid network. However, with respect to the arrows, there is a unique graph for each source node (root node). Arrows point “away” from the source node (root node). Prior to running modified Dijkstra's algorithm for a given root node, the arrows may be applied to indicate the directionality of potential links.

The topology map 1100 represents the example hybrid network shown in FIG. 3. The topology map 1100 includes interface-specific nodes representing the interfaces for each device. Additionally, the topology map 1100 includes device-internal nodes (e.g., “a0,” “b0,” “c0,” “d0,” “e0,” “f0,” “g0,”) representing each device in the network. For example, a node 1115 is added to represent device A (labeled as “a0”). Nodes 611, 612, 613 (representing interfaces “a1,” “a2,” and “a3”) may be capable of direct traffic to node 1115 (representing “a0” for device A). In one interpretation, the “a0” node 1115 may represent higher layers of the protocol stack than the MAC layer associated with the interfaces. Similar to node 1115 (“a0”), the topology map includes node 1125 (“b0”), node 1135 (“c0”), node 1145 (“d0”), node 1155 (“e0”), node 1165 (“f0”), and node 1175 (“g0”).

In addition to representing device-internal nodes, a topology map may include virtual nodes to represent various broadcast route options. A variety of broadcast functionality may be “built-in” to the network protocol or the underlying physical layer protocol. To accurately describe the broadcast capabilities and associated link costs, the topology map 1100 depicts virtual nodes (depicted as ovals in the accompanying FIGS. 11-15). Directional arcs in the topology map are used to express unidirectional nature of some links (e.g., from an interface node to a device node, or from an interface node to a virtual node).

One type of broadcast transmission is referred to as physical layer (PHY) broadcast. When a frame is PHY broadcast on a shared network segment, multiple devices in the shared network segment typically receive a copy of the broadcast frame, and it is not practical to limit which devices on that shared network segment will receive the PHY broadcast. Additionally, there is one “link” cost to reach all devices on that shared network segment. These considerations may impact the development of a routing tree for broadcast traffic.

Another type of broadcast transmission is referred to as broadcast-to-unicast conversion. In broadcast-to-unicast conversion, a broadcast may be transmitted in the form of unicast frames to each intended broadcast recipient. Depending on the link costs to each broadcast recipient, the broadcast-to-unicast conversion may increase or decrease the total cost of transmitting the broadcast data over the shared network segment. Hybrid devices may implement either or both of the aforementioned types of broadcast transmission for particular interfaces, depending on the interface type or underlying communication protocol. For example, different physical layer protocols may specify different capabilities, as described below using PLC and WLAN examples.

In FIG. 11, node 672 (“g2”) is a PLC interface and can selectively use either PHY broadcast or broadcast-to-unicast conversion to send out broadcast traffic to other PLC interfaces coupled to the PLC medium. Broadcast node 1179 (“g2bc”) is a virtual node that represents a PHY broadcast domain from node 672 (representing interface “g2”) to reach nodes 613, 633, 642 (essentially all other nodes on the PLC network segment coupled by interfaces “a3,” “c3,” and “d2”). The link cost to broadcast node 1179 may be determined based on PHY rates for PHY broadcast traffic that will reach all nodes on the network segment. The link cost (“80”) for the broadcast node 1179 represents the total link cost for node 672 to send a PHY broadcast that will reach all of the nodes 613, 633, 642. In an implementation, the link cost for broadcast node 1179 may be represented as a cost for the link from node 672 (“g2”) to broadcast node 1179 (“g2bc”), and the links from broadcast node 1179 to each of nodes 613, 633, 642 may be represented with a nominal value (such as zero).

In the example in FIG. 11, interface “g2” is configured to use either PHY broadcast (via broadcast node 1179) or to use broadcast-to-unicast conversion (shown as broadcast node 1178). Broadcast-to-unicast conversion results in a broadcast message being transmitted as unicast frames. Broadcast-to-unicast conversion can be represented by a virtual node in the topology map. A broadcast-to-unicast conversion route is represented by an arc from a broadcasting node to the virtual node, then arcs from the virtual node to each other interface on the medium. When using the broadcast-to-unicast conversion, a broadcasting node cannot elect to send a transmission to a selected neighbor without sending to others. Rather, the broadcast-to-unicast conversion route will result in separate unicast transmissions to every other device on a medium. For example, although broadcast node 1178 is illustrated as a virtual node in the topology map 1100, when broadcast traffic is routed through that virtual node, the interface “g2” will use broadcast-to-unicast conversion to send unicast frames to each of the devices in the broadcast domain. In a topology map for broadcast traffic, if broadcast-to-unicast conversion is represented by a virtual node associated with a broadcasting node, then all other unicast links for that broadcasting node can be removed or disabled in the topology map for routing purposes.

FIG. 11 shows the aggregate link cost of broadcast node 1178 as “140” which is the sum of three separate unicast transmissions (link cost “30” for unicast frame to “c3,” link cost of “40” for unicast frame to “a3,” and link cost “70” for unicast frame to “d2”). When determining the routing tree, an algorithm may initially consider each broadcast-to-unicast transmission cost individually, so the link costs of “70,” “40,” and “30” may be maintained for the links from broadcast node 1178 to nodes 642, 613, 633, respectively. Because the link costs of the individual transmissions are already accounted, the link cost from node 672 to broadcast node 1178 may be negligible (such as “0”). For some algorithms that optimize the routing tree, as discussed further in this description, the algorithm may also consider the broadcast-to-unicast transmissions as a bundle for optimization purposes, and the bundle would have an aggregate link cost of “140” associated with using broadcast-to-unicast conversion on that network segment.

In the example in FIG. 11, the PLC interfaces “a3” and “d2” (depicted as node 613 and node 642, respectively) may be configured to only use PHY broadcast (e.g., as robust, ROBO, mode) to transmit broadcast frames. In other words, interfaces “a3” and “d2” do not support broadcast-to-unicast conversion, so that option is not reflected in the topology map 1100. Conversely, the PLC interface “c3” (node 633) may be configured to use only broadcast-to-unicast conversion, represented by broadcast node 1138 (associated with separate unicast transmissions with link costs “40,” “50,” and “30” for an aggregate link cost of “120”). Because the PLC interface “c3” (node 633) does not support PHY broadcast, in this example, the topology map 1100 does not include a virtual node to represent the PHY broadcast domain. Thus, the use of virtual nodes in the topology map can accurately depict the broadcast capabilities of each interface, depending on the interface configuration or protocol capability.

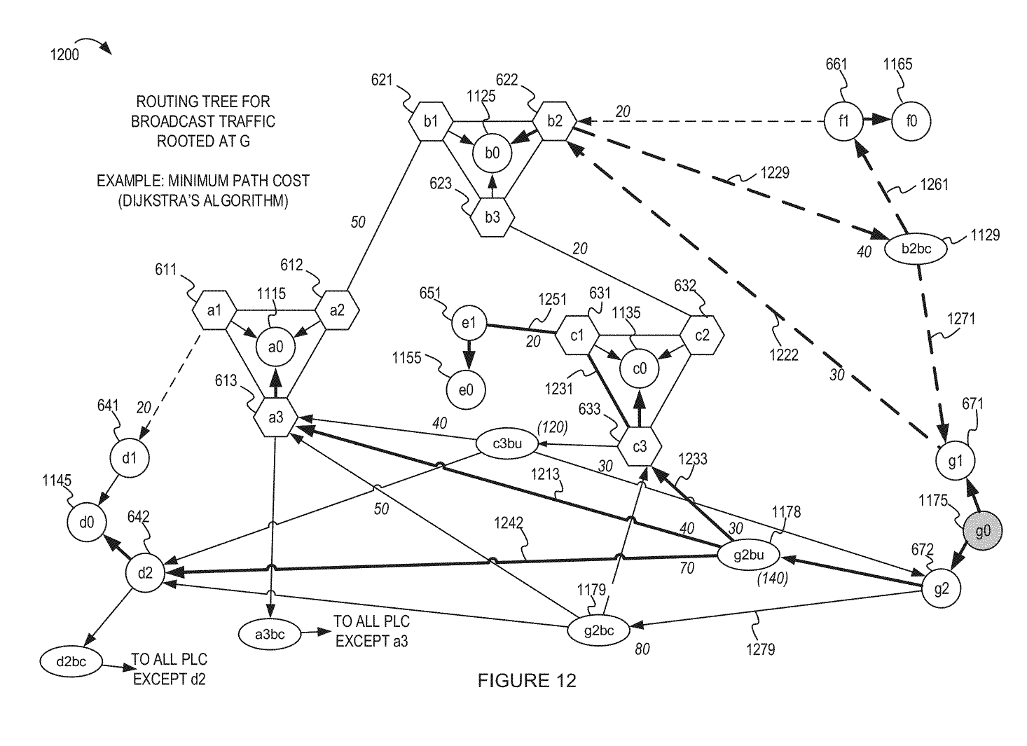

In the example of FIG. 12, node 622 (“b2”) is a wireless access point (AP) which is not capable of using broadcast-to-unicast conversion. For example, IEEE 802.11 describes wireless local area networks. According to IEEE 802.11, when a STA has broadcast traffic, the STA will send it directly to the AP as an upstream transmission that operates similar to a unicast transmission. The AP then sends the broadcast traffic using PHY broadcast to reach all the STAs in the wireless local area network. Therefore, the AP cannot use broadcast-to-unicast conversion for broadcast traffic. Instead, the AP is configured to use PHY broadcast transmissions, which is represented as broadcast node 1129. The broadcast node 1129 (“b2bc”) may represent a capability to PHY broadcast from node 622 (AP at interface “b2”) to reach node 661 (STA at interface “f1”) and node 671 (STA at interface “g1”). The directional arcs in the topology map 1100 are tailored to represent how broadcast traffic is handled by each device and device interface. The broadcast node 1129 (“b2bc”) has an incoming directional link from node 622 (“b2”) and outgoing directional links to the station interfaces associated with node 661 (“f1”) and node 671 (“g1”). Since the interfaces “f1” and “g1” are wireless clients “stations” or STAs) in the WLAN, they are configured to send broadcast traffic by first transmitting the broadcast frame to the AP interface “b2” so that the AP interface “b2” will rebroadcast the broadcast frame (using node 1129, “b2bc”).

Having described the topology map 1100 for broadcast traffic, and determining link costs associated with broadcast links, a routing tree for broadcast traffic may be determined. There may be different algorithms to determine a routing tree for broadcast traffic. In one embodiment, all devices in the network will determine and follow a same routing tree for broadcast traffic from a root node. In an embodiment, the devices will determine routing trees based on each source considered as a root node, such that a common routing tree will be used by all devices in the network depending on a source address of the broadcast transmission. FIGS. 12-14 illustrate different routing trees for broadcast traffic that may be generated following the topology map of FIG. 11. The example routing trees in FIGS. 12-14 are for broadcast traffic originating at device G, and differ from each other based on the algorithm used to determine the routing tree. Note that the edges adjacent to device-internal node 1175 (“g0”) for device G in these figures are directed away from node 1175 (“g0”), whereas the edges adjacent to the device-internal nodes for all other nodes remain directed toward the device-internal node for their respective device. The source device for which the broadcast tree is being computed has outgoing edges from its device-internal node so that the routing tree can utilize all egress interfaces of the source device for the broadcast traffic. The edges adjacent to device-internal nodes for the other devices in the network have incoming edges to their device-internal nodes.

FIG. 12 depicts a topology map including a routing tree for broadcast traffic, in accordance with an embodiment of this disclosure. FIG. 12's topology map is the same as the topology map shown in FIG. 11, except that the routing tree is shown using bold lines. In FIG. 12, the algorithm to generate the routing tree is described as a minimum path cost algorithm. For example, the routing tree may be generated using the topology map 1200 following an application of a modified Dijkstra's algorithm. The modified Dijkstra's algorithm iteratively selects routes to each node based on the link cost to each node. The original Dijkstra's algorithm does not handle broadcast traffic, and therefore did not consider PHY broadcast or broadcast-to-unicast paths. Using a modified Dijkstra's algorithm (such as described in FIG. 17), a routing tree for broadcast traffic can accommodate broadcast paths to reach device-internal nodes in the topology map. Using the modified Dijkstra's algorithm, the device determines a lower link cost (“30”) associated with transmitting a broadcast-to-unicast conversion frame from node 672 to node 633 via link 1233 than the link cost (“80”) associated with transmitting a PHY broadcast frame from node 672 to broadcast node 1179 via link 1279.

The routing tree in FIG. 12 makes use of the broadcast node 1129 for broadcasting the frame via the WLAN associated with node 622. In the routing tree, the device G transmits the broadcast frame via link 1222 from node 671 to node 622. Then node 622 forwards the broadcast frame to node 1125 (to inform device B, at “b0”).

Following the routing tree, node 622 will retransmit the broadcast frame using a PHY broadcast, represented as a transmission to broadcast node 1129. The link cost to transmit the broadcast frame to broadcast node 1129 is “40.” Although the broadcast node 1129 isn't an actual device, the transmissions sent to broadcast node 1129 are received by nodes 661, 671 which are associated with the WLAN. The link cost from broadcast node 1129 to nodes 661, 671 (via links 1261, 1271, respectively) is nominal (e.g., “0”). Note that node 622 (interface “b2”) will use a PHY broadcast via broadcast node 1129 for the broadcast traffic. This is because interface “b2” is an AP interface that does not support broadcast-to-unicast conversion. Therefore, even though the link cost from STA interface “f1” to AP interface “b2” is less expensive (“20”), the AP interface “b2” could not use that path because the AP interface “b2” only supports PHY broadcast and not broadcast-to-unicast. The unidirectional arcs in the topology map are used to prevent the algorithm from selecting that improper paths based on the broadcast capabilities for each interface-specific node.

If device B is following the routing tree, when node 622 determines the broadcast frame is from device G, node 622 does not bridge the broadcast frame to other interface nodes of device B because they are not in the routing tree. Similarly, when node 671 receives the broadcast frame, node 671 will discard the broadcast frame as a received duplicate of the broadcast frame that it originally transmitted. When node 661 receives the broadcast frame, node 661 sends it to device-internal node 1165 to inform device F about the broadcast frame.

Returning to the PLC connections, device G sends the broadcast frame using broadcast-to-unicast conversion to node 633 at device C via link 1233. When node 633 receives the broadcast frame, node 633 sends the broadcast frame to node 1135 (to inform device C, at “c0”). Node 633 also forwards the broadcast frame to node 631 via link 1231. Node 631 then transmits the broadcast frame via link 1251 to node 651 at device E. Node 672 also transmits the broadcast frame using broadcast-to-unicast conversion to node 613 at device A via link 1213, and to node 642 at device D via link 1242.

The routing tree of FIG. 12 has a total link cost (sum of all links of the routing tree) of “230.” The longest path in the routing tree is from node 671 (“g1”) via link 1222 (link cost=“30”) to node 622 (“b2”), then from node 622 via link 1229 (link cost=“40”) to node 1129 (“b2bc”). Therefore, the cost of the longest path is “70.” Table 1 shows the calculation of the total link cost for the routing tree. The total link cost is “230.”

TABLE 1

| link | Link cost |
|---|---|
| g2-c3 | 30 |
| g2-a3 | 40 |
| g2-d2 | 70 |
| g1-b2 | 30 |
| b2-b2bc | 40 |
| c1-e1 | 20 |
| TOTAL | 230 |

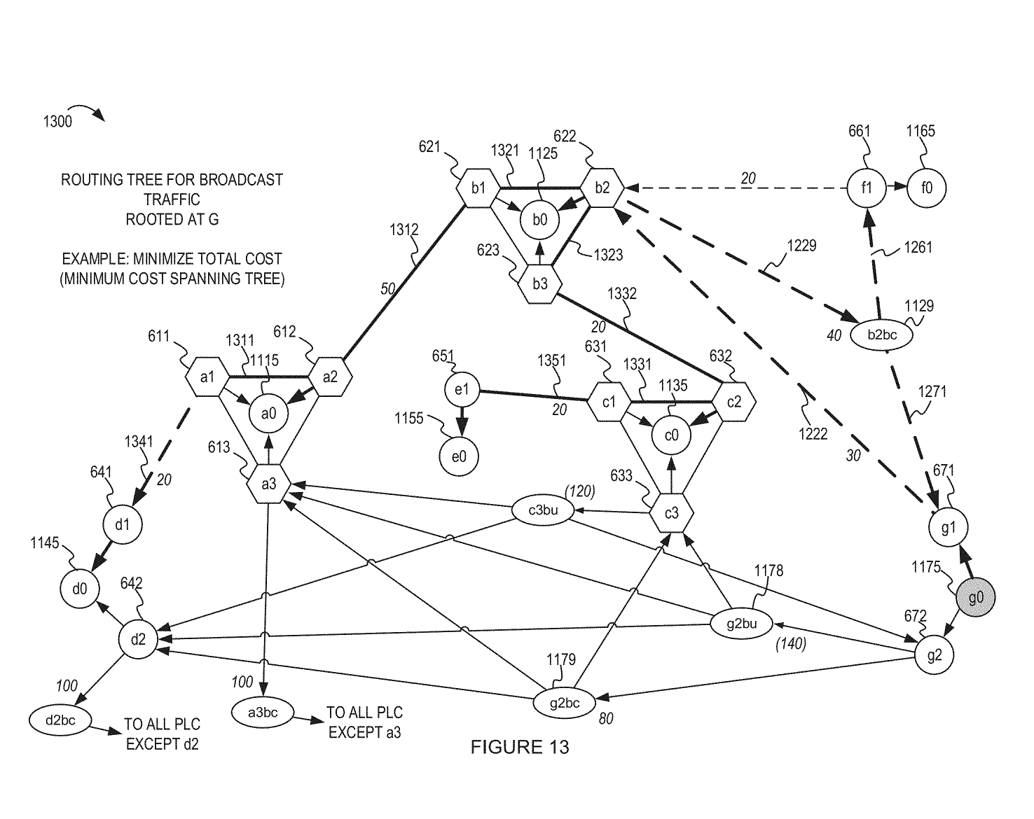

FIG. 13 depicts a topology map with a routing tree for broadcast traffic using a minimum total cost spanning tree algorithm, in accordance with an embodiment of this disclosure. In FIG. 13, the topology map is similar to the topology map of FIG. 11. While FIG. 12 shows a first routing tree for FIG. 11's topology map, FIG. 13 shows a second routing tree.

In FIG. 13, the algorithm to generate the second routing tree is described as a minimum total cost algorithm (e.g. minimum cost spanning tree algorithm). For example, the second routing tree may be generated using the topology map 1300 following an algorithm which aims to get the lowest total link cost (adding all the link costs for links in the second routing tree). The resulting second routing tree includes broadcast transmissions via link 1222, 1229, 1261, and 1271, similar to the first routing tree. However, the second routing tree includes the node 622 bridging the broadcast frame via links 1321, 1323 to nodes 621, 623, respectively. From node 623, the broadcast frame is retransmitted via link 1332 to node 632. Node 632 sends the broadcast frame to node 1135 (to inform device C at “c0”) and bridges the broadcast frame via link 1331 to node 631. Node 631 retransmits the broadcast frame via link 1351 to node 651, which sends the broadcast frame to node 1155 (to inform device E at “e0”).

Returning to device B, when node 621 receives the broadcast frame, node 621 retransmits the broadcast frame via link 1312 to node 612 at cost “50.” Node 612 sends the broadcast frame to node 1115 (to inform device A at “a0”) and bridges the broadcast frame via link 1311 to node 611. Node 611 retransmits the broadcast frame via link 1341 to node 641. Node 641 sends the broadcast frame to node 1145 (to inform device D at “d0”). Note that the link from node 633 (“c3”) to node 613 (“a3”) has a cost of “40.” However, that link will not be used in isolation from the links from “c3” to other devices in the broadcast domain (such as the link from “c3” to “d2” having a cost of “50” and the link from “c3” to “d2” having a cost of “30”). This is because together all these links represent a broadcast-to-unicast conversion domain, having a total cost of “120.” While the link from “c3” to “a3” by itself would represent a lower cost way to get the broadcast frame to device A, when considering the costs of the other links required by the broadcast-to-unicast conversion (together represented as “c3bu” having a cost of “120”), the link 312 from node 621 (“b1”) to node 612 (“a2”) is less costly.

The resulting second routing tree of FIG. 13 has a lower total link cost than the first routing tree of FIG. 12. The second routing tree of FIG. 13 has a total link cost (for all links of the routing tree) of “180.” The longest path in the second routing tree is from node 671 (“g1”) via link 1222 (link cost=“30”) to node 622 (“b2”), from node 622 via link 1321 to node 621 (link cost=“0”), then from node 621 via link 1312 (link cost=“50”) to node 612, from node 612 via link 1311 to node 611 (link cost=“0”), and then from node 611 via link 1341 (link cost=“20”) to node 641. Therefore, the cost of the longest path is “100.” Table 2 shows the calculation of the total link cost for the second routing tree. The total link cost is “180.”

TABLE 2

| link | Link cost |
|---|---|
| g1-b2 | 30 |
| b2-b2bc | 40 |
| b1-a2 | 50 |
| b3-c2 | 20 |
| c1-e1 | 20 |
| a1-d1 | 20 |
| TOTAL | 180 |

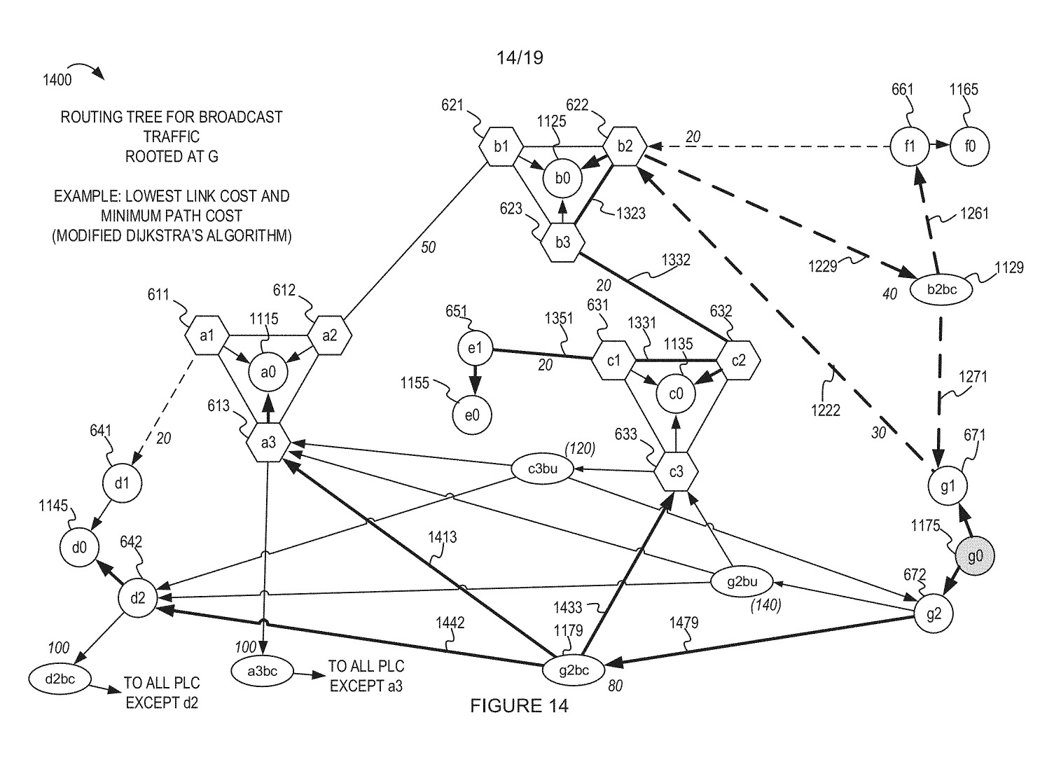

FIG. 14 depicts a topology map with a routing tree for broadcast traffic using another algorithm, in accordance with an embodiment of this disclosure. The topology map 1400 includes the same nodes as topology maps 1200, 1300 of the previous figures. The algorithm used in FIG. 14 produces a routing tree (a third routing tree) that considers path costs associated with broadcast paths, in addition to link costs. The algorithm may be described as follows: when executing Dijkstra's algorithm, select the route that results in the lowest cost to reach the node being considered, except in the case where a broadcast link is available, in which case use the lowest total link cost. For example, the algorithm will use a broadcast pseudo-node if doing so will result in a lower total cost to reach the target nodes.

The third routing tree of FIG. 14 uses the same links 1222, 1229, 1271, 1261, 1323, 1332, 1331, 1351 described previously. However, different from FIG. 12 and FIG. 13, in FIG. 14, the third routing tree uses a PHY broadcast transmission via broadcast node 1179 to reach device A and device D. The PHY broadcast frame is transmitted from node 672 via link 1479 to broadcast node 1179. The PHY broadcast transmission is received at nodes 613, 633, 642 (via virtual links 1413, 1433, 1442, respectively) because the nodes are coupled to the PLC medium associated with broadcast node 1179. The link costs for links 1413, 1433, 1442 are nominal (“0” in the example of FIG. 14) because the link cost (“80”) for the PHY broadcast transmission is already accounted for in link 1479 (or, alternatively, the cost for PHY broadcast may be stored in association with the broadcast node 1179).

The longest path in the third routing tree is from node 672 (“g2”) via link 1479 (link cost of “80”) to node 1179 (“g2bc”). Therefore, the cost of the longest path is “80.” Table 3 shows the calculation of the total link cost for the third routing tree. The resulting third routing tree of FIG. 14 may has a total link cost (for all links of the routing tree) of “190.”

TABLE 3

| link | Link cost |
|---|---|
| g2-g2bc | 80 |
| g1-b2 | 30 |
| b2-b2bc | 40 |
| b3-c2 | 20 |
| c1-e1 | 20 |
| TOTAL | 190 |

Comparing the routing trees in FIGS. 12-14, it can be seen that that when selecting among routing trees for broadcast traffic, there are potential tradeoffs between optimizing based on the total cost to deliver broadcast frames to all devices vs. the maximum path cost to deliver broadcast frames. The latter implies better service (lower delays) to deliver the broadcast traffic, while the former implies minimizing the total network bandwidth required to deliver broadcast frames. Table 4 summarizes the metrics for each routing tree.

TABLE 4

| Broadcast path optimization | Total cost | longest path |
|---|---|---|
| First routing tree of FIG. 12 | 230 | 70 |
| Using modified Dijkstra's algorithm | | |
| to minimize path cost to each device | | |
| Second routing tree of FIG. 13 | 180 | 100 |
| Using spanning tree algorithm to | | |
| minimize total cost (minimum cost | | |
| spanning tree) | | |
| Third routing tree of FIG. 14 | 190 | 80 |
| Using modified Dijkstra's algorithm | | |
| to optimize for lowest link cost & | | |
| min. path cost | | |

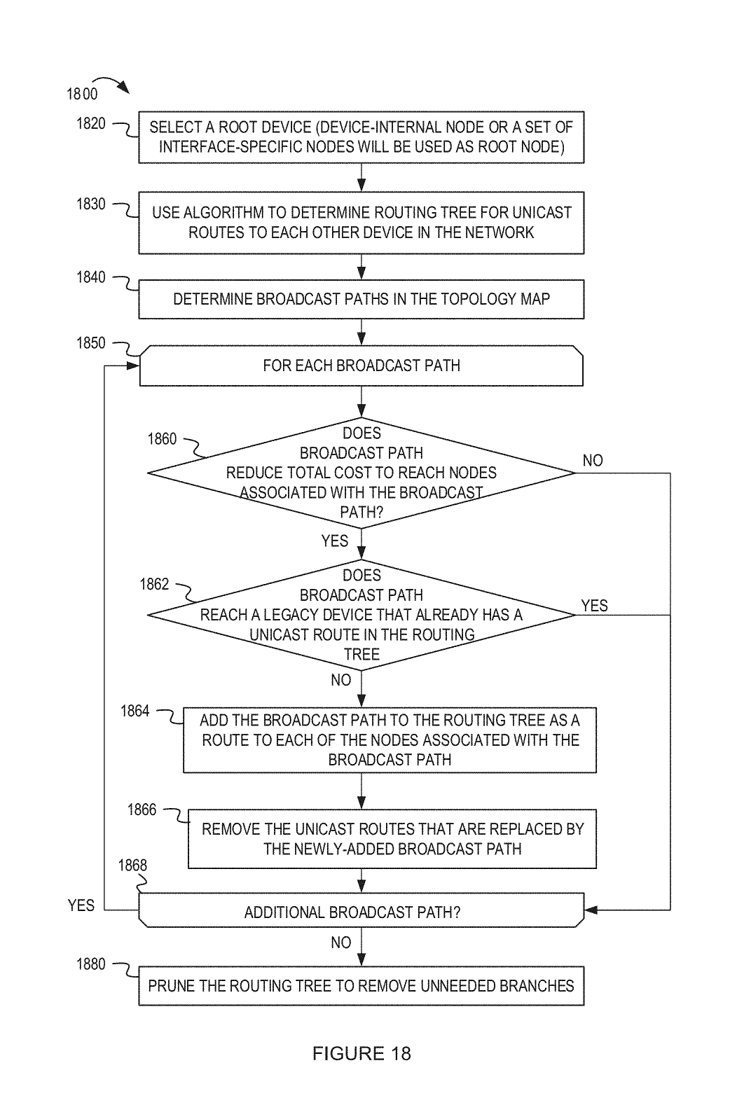

In determining the third routing tree of FIG. 14, a conventional Dijkstra's algorithm may be modified with some additional rules that accommodate broadcast capabilities. Example modifications to Dijkstra's algorithm are described in FIG. 17 and FIG. 18.

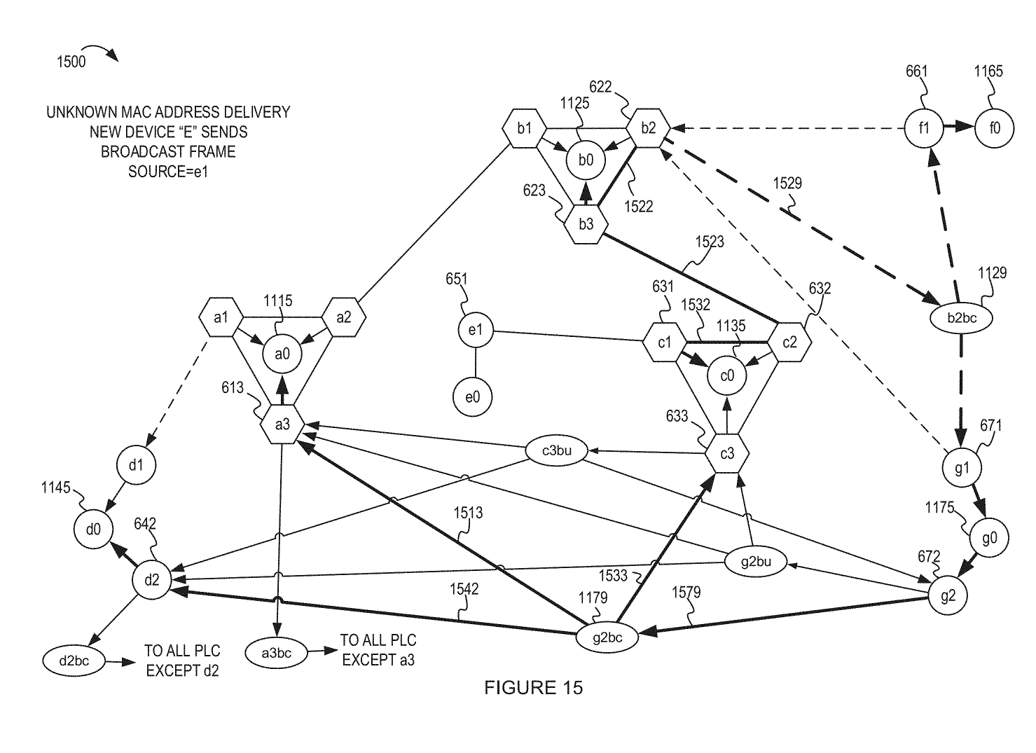

FIG. 15 depicts a topology map, and a routing tree for handling traffic for a new or unknown network address, in accordance with an embodiment of this disclosure. When a new device is first added to the hybrid network, the other devices may be unaware of the new device. The new device may transmit frames for topology discovery or announcement. For example, the new device may transmit address resolution protocol (ARP) frames, or the like. If the new device is a legacy device, the new device may not be capable of sending specialized topology messages associated with a protocol used by the hybrid devices. The new device may transmit frames that have an unknown destination address, a broadcast/multicast destination address, or may have an unknown source address.

To accommodate discovery and routing of packets for the new device, when an existing device in the routing tree receives the frame from the new device, the existing device retransmits the frame according to a routing tree used among all other devices in the network. For example, a “default” common routing tree may be used for flooding the frames from the new device, until the new device is added to the topology map and routing trees for the new device are established. Each device can determine its position in the default common routing tree and route frames accordingly. For example, the device will route the frame downstream according to the routing tree, and will also route the frame upstream to the root of the default common routing tree.

The default common routing tree may be selected using a standardized approach at each hybrid device. For example, the default common routing tree may be a routing tree rooted at an interface that has the lowest numerical MAC address. The default common routing tree may be selected based on a routing tree for broadcast traffic. In one embodiment, a central coordinator in the network may establish the default common routing tree.

When a hybrid device receives the initial frames from the new device, the hybrid device will forward the initial frames in accordance with the default common routing tree. If the frame is received at a node in the middle of the routing tree, the frame may also be forwarded in reverse direction of the routing tree so that the frame can reach the root node (and other parts of the routing tree via the root node). An example of this process is described in FIG. 15. For brevity, it will be assumed that the third routing tree (from FIG. 14) rooted at node 1175 is the default common routing tree to use for flooding the network with frames having an unknown address. In other embodiments, the default common routing tree is optimized differently from other routing trees used for delivery of unicast or broadcast frames.

In the example of FIG. 15, device E is a new device added to the hybrid network. Initially, device E may not be in the topology map 1500, but is later mapped as it is discovered. In the example, interface “c1” of device C receives traffic from an unknown interface “e1.” The frame from interface “e1” contains an unknown MAC address (either an unknown source address or unknown destination address) or a broadcast destination address. Even though the default common routing tree is rooted at device G (at node 1175), device C is the first device to receive the frame from the new device E. Device C determines that it is an end node in the default common routing tree and forwards the frame upstream traversing the default common routing tree in the reverse path towards the root node. The frame is sent to node 1135 (to inform device C at “c0”) and is bridged via link 1532 to node 632. From node 632, the frame is transmitted via link 1523 to node 623. From node 623, the frame is sent to node 1125 (to inform device B at “b0”) and bridged via link 1522 to node 622. From node 622, the frame is broadcast via link 1529 to broadcast node 1129. The broadcast node 1129 is a virtual node that represents a broadcast domain that will reach nodes 661, 671. When node 661 receives the broadcast frame, node 661 will send the broadcast frame to node 1165 (to inform device F at “f0”). When node 671 receives the broadcast frame, node 671 will send the broadcast frame to node 1175 (to inform device G at “g0”). Device G recognizes that it is the root node for the default common routing tree and then retransmits the broadcast frame using other branches of the default common routing tree. In this way, the broadcast frame will be retransmitted by node 672 via link 1579 to broadcast node 1179. Broadcast node 1179 represents a broadcast domain with virtual links 1513, 1533, 1542 to nodes 613, 633, 642, respectively. When node 613 receives the broadcast frame, node 613 will send the broadcast frame to node 1115 (to inform device A at “a0”). When node 642 receives the broadcast frame, node 642 will send the broadcast frame to node 1145 (to inform device D at “d0”). When node 633 receives the broadcast frame, node 633 may discard the broadcast frame since node 633 does not have a forwarding rule according to the default common routing tree.

In one embodiment, when a device routes a frame having an unknown destination address, a broadcast/multicast destination address, or an unknown source address, the device may modify the frame to provide an indication that the frame is being routed according to the default common routing tree. For example, the indication may be a tag or marker added to the frame (e.g., in a header or preamble). In one embodiment, IEEE 802.1D VLAN tags may be used to mark unknown address frames. Alternatively, an address field (e.g., source address or destination address) in the frame may be overwritten to include a reserved address as the indication that the frame is being routed in accordance with the default common routing tree. By including the indication in the frame, other devices will determine that the frame should be routed in accordance with the default common routing tree, and act accordingly.

FIG. 16 depicts a flow diagram including operations for topology mapping in accordance with an embodiment of this disclosure. The topology map is determined based on topology information gathered and shared via a variety of processes. In various embodiments, topology information is gathered using a combination of broadcast topology messages, topology query and response messages, and source address learning. Hybrid devices may discover legacy devices in the hybrid network by the existence of (or lack of) special tags that hybrid device insert into certain frames. Legacy devices that are discovered by each hybrid device are included in a list of legacy devices in a topology protocol message. In one embodiment, all hybrid devices in the hybrid network learn the complete topology of the hybrid network.

The flow 1600 begins at block 1610. At block 1610, a device may use one or more topology discovery processes to obtain topology information. There are several topology discovery processes which may be used in parallel or in various combinations. Topology information discovered from a first topology discovery processes may be used to refine topology information discovered from a second topology discovery process. From block 1610, the flow 1600 may continue to one or more topology discovery processes represented by blocks 1620, 1630, 1640, 1650, 1660, and 1670. Once topology information has been obtained, the flow 1600 may continue from block 1610 to block 1680.

At block 1620, the device may monitor traffic to discover devices. The device may use techniques, referred source address learning, to associate a neighbor device with an ingress interface when the ingress interface receives a frame having a source address of the neighbor device.

At block 1630, the device may send or receive topology discovery message(s). As described above, the hybrid devices may follow the IEEE P1905.1 standard. The P1905.1 protocol defines messages, such as the Topology Discovery Message, Topology Query/Response messages, or other messages communicated between hybrid devices to share information about the topology of the hybrid network. Other protocols may have other topology discovery messages that may be used to discover the topology of the network. Described previously, messages called link state announcements (LSAs) may be exchanged by hybrid devices to indicate neighbor devices for each interface of the hybrid device. The LSAs may also include link costs, link status, and other information that may be used to refine the topology map.

At block 1640, the device may send or receive topology query messages(s). At block 1650, the device may send or receive topology response messages(s) in response to topology query messages(s). The topology query messages(s) and topology response messages may be unicast messages sent between pairs of devices that exchange detailed information about the topology map at each device.

At block 1660, the device may send or receive topology information to/from a central coordinator. For example, a plurality of devices in the network may send topology information to the central coordinator. The central coordinator is a node selected to aggregate the topology information and may perform other functions for controlling operation of devices in the hybrid network. The central coordinator may send aggregated topology information to the devices in the hybrid network.

At block 1670, the device may send or receive address resolution protocol (ARP) messages. ARP messages are often used to map network layer (IP) addresses with MAC addresses. However, the ARP messages may also be used for discovering locations of devices in the topology map. Using gratuitous ARP, a device may force a particular interface to be used for frames directed to the device. The ARP messages may be used to update the topology map.

At block 1680, the device may determine which devices are hybrid devices and which devices are legacy devices. Discovery of legacy devices may be helpful to update the topology map with the behavior expected by the legacy devices. For example, a legacy device may bridge traffic between network segments in a way that is not apparent to hybrid devices until the legacy device is identified. Legacy devices may be discovered by adding tags to frames, where the tags are recognized by hybrid devices and not recognized by legacy devices. A legacy device may discard the frame when it receives the unrecognized tag. By monitoring and sharing information about which devices receive frames with the tag, the hybrid devices may discover a legacy bridging device in the network.

At block 1690, the device may determine the topology map using any information obtained using the processes from blocks 1620 to 1680.

FIG. 17 depicts a flow diagram including modifications to Dijkstra's algorithm for determining a routing tree for a hybrid network. The algorithm aims to calculate the lowest cost paths from one device to all other devices in the topology map. Dijkstra's algorithm is one example of a shortest path algorithm. Other shortest path algorithms may be used with embodiments of this disclosure, including Bellman-Ford algorithm.

The flow 1700 begins at block 1710. At block 1710, the algorithm begins by resetting the routing tree (e.g., clear initial link cost for all nodes except root node, mark all nodes except root node as unvisited, etc.). At block 1720, the algorithm creates a set of unvisited nodes that have forwarding capabilities. As one modification to traditional Dijkstra's algorithm, the set of unvisited nodes only includes nodes that have forwarding capabilities. Non-forwarding nodes are still included in topology map and are considered for neighbor relationships during execution of the algorithm. However, the non-forwarded nodes are not included in the list of unvisited nodes and are not “visited” (as a “current node”) during execution of the algorithm. This modification enables the algorithm to determine path cost to non-forwarding nodes while avoiding paths through non-forwarding devices (which would result in incorrect path cost). Pseudo-nodes are not included in the set of nodes to be visited. During execution of the modified Dijkstra's algorithm, the total cost to reach one or more neighbor nodes by passing through a pseudo-node is considered when calculating route cost and updating the routing tree.

At block 1730, the algorithm initially sets the root node as “current node.” Operations from loop start 1740 to loop end 1758 are repeated for each neighbor node of the current node. A neighbor node is a node that has at least one link from the current node to the neighbor node. Since there may be more than one link the algorithm in FIG. 17 may consider each link to find a lowest path cost to the neighbor node. Loop start 1750 to loop end 1750 are repeated for each link. Loop start 1750 begins the loop to identify a current link. At decision 1752, the algorithm determines whether a first path cost (via the current link) to the neighbor node is lower than an existing path cost for an existing route from the root node to the neighbor node. The first path cost is a sum of link costs from the root node to the neighbor node via the first link. The existing path cost is a sum of link costs from the root node to the neighbor node via the existing route in the routing tree. If the first path cost is higher, the current link is not used in the routing tree. The flow continues to loop end 1754 which determines whether to consider additional links. If there are additional links, the flow 1700 returns to loop start 1750 to set the additional link as the next “current link” to consider. If there are no additional links, flow continues from the loop end 1754 to loop end 1758.

Returning to decision 1752, if the algorithm determines that a first path cost for current link is lower than an existing path cost for an existing route (if any) to the neighbor node, then the flow 1700 continues to block 1756. At block 1756, the algorithm adds the current link to the routing tree as a new route from the current node to the neighbor node. If there is an existing route, the existing route is replaced by the new route. At block 1757, the algorithm may store the first path cost in association with the new route to the neighbor node.

At loop end 1758, the flow 1700 returns to loop start 1740 if there are additional neighbor nodes. Otherwise, the flow 1700 continues to block 1760.

At block 1760, the algorithm removes the current node from the set of unvisited nodes, and the flow continues to decision 1762. At decision 1762, the algorithm determines whether there are any remaining unvisited nodes. If there are no remaining unvisited nodes, the algorithm may end. If there are remaining unvisited nodes, the flow may continue to block 1770. At block 1770, the algorithm selects a node to be the next “current node” for the next iteration of the algorithm. For example, the selected next “current node” may have the lowest path cost to the root node from among the set of unvisited nodes that have forwarding capabilities. The flow then repeats operations from 1740-1770 using the new current node.

The modified Dijkstra's algorithm may also be initially used for determining a routing tree for broadcast traffic. When executing the modified Dijkstra's algorithm for broadcast topology graphs, the link costs for an interface-specific node in a non-forwarding device (such as a legacy device) may be propagated to a device-internal node in the device. If the cost to reach the device-internal node is less than the current tentative cost, the route is chosen and the path cost is updated accordingly. The routing tree may be updated to show that the new route to the device-internal node includes the interface-specific node to reach the device-internal node.

FIG. 18 depicts a flow diagram including operations for an algorithm to generate unicast and broadcast routing trees in accordance with an embodiment of this disclosure. The algorithm in FIG. 18 is designed to take broadcast delivery options into account when optimizing the routing tree and avoid confused source address learning in legacy learning bridges by utilizing where possible unicast routing tree paths for the broadcast routing tree.

A multi-interface device, such as a legacy bridging device, may use source address learning to determine whether to bridge traffic. In order to avoid “teaching” a legacy device about an interface not in the same network segment, the algorithm may begin by determining the unicast routes from all interfaces in the source (root) node to all nodes in the routing tree. Therefore, the routing tree may utilize the same links for unicast traffic and broadcast traffic. Once the routing trees have been created for unicast traffic, it can be optimized with broadcast paths that result in a lower total cost and that do not impact operation of the legacy devices. Thus, legacy devices that use source address learning will not become confused by the same source address being received at a multiple interfaces. FIG. 18 provides an algorithm that considers whether a broadcast path results in a lower total cost to reach the nodes associated with the broadcast path and whether the broadcast path could cause problems with a legacy device.

The flow 1800 begins at block 1820. At block 1820, the algorithm selects a root device. A device-internal node of the root device may serve as the root node and may have outbound links (with nominal or zero cost) to each interface-specific node associated with the root device. Alternatively, a set of interface-specific nodes for the root device may be considered as a root node for execution of the algorithm. At block 1830, the algorithm determines a unique routing tree with unicast routes from each interface of the root device to each interface of the other devices in the network. For example, routing tree may be determined using a modified Dijkstra's algorithm as described in FIG. 17. The routing tree may be initially determined using only unicast routes prior to introducing the broadcast paths. For example, the broadcast nodes may be ignored or removed from the topology map. Furthermore, when executing the algorithm, only forwarding nodes may be included in the set of unvisited nodes, so that non-forwarding nodes are not “visited” as a current node during execution of the algorithm to determine the routing tree. At block 1840, the algorithm determines broadcast opportunities and adds broadcast nodes to represent broadcast delivery options in the topology map.

Operations from loop start 1850 to loop end 1866 are repeated for each broadcast path considered. Broadcast paths are determined and considered in a deterministic order. For example, the algorithm may define a new set of unvisited nodes to include the broadcast nodes, and select from the new set of unvisited nodes the first node having the lowest path cost from the root node. After the current broadcast path (associated with the first node) is considered, the first node is removed from the set of unvisited nodes and the steps to select a new broadcast path (using the set of unvisited nodes) may be repeated. For each broadcast path, the algorithm determines whether to use the broadcast path or not. At decision 1860, the algorithm determines whether using the broadcast path will reduce the total cost to reach the nodes associated with the broadcast path. If it does not, the broadcast path is not used, and the flow continues to loop end 1868. If the broadcast path does reduce the total cost, then the flow continues to decision 1862. At decision 1862, the algorithm determines whether the broadcast path will reach a legacy device that already has a unicast route in the routing tree. If so, the broadcast path may be avoided to prevent confusion to the legacy device, and the flow continues to loop end 1868. If the broadcast path will not confuse a legacy device already having a unicast route in the routing tree, the flow continues to block 1864. At block 1864, the algorithm adds the broadcast path to the routing tree as a route to each of the nodes associated with the broadcast path.

At block 1866, the algorithm may prune the broadcast routing tree to remove any unicast routes that can be replaced by the newly-added broadcast path. For example, if a unicast route terminates at a device-internal node for a device that will receive the broadcast message via the broadcast path, then the unicast route may be pruned (trimmed) back to the previous device associated with that unicast route. Stated another way, unicast routes for delivery of broadcast traffic should be pruned if there is a unicast-to-broadcast conversion route (e.g., using a broadcast pseudo-node) that delivers broadcast traffic to the same node.

At loop end 1868, the flow 1800 returns to loop start 1850 if there are additional broadcast paths to continue. Otherwise, at loop end 1868, if there are no additional broadcast paths to consider, the flow 1800 continues to block 1880 to further optimize the routing tree.

At block 1880, the algorithm may prune the broadcast routing tree to remove unneeded branches. Unneeded branches are those that terminate at an interface-specific node but are not used to reach any device-internal nodes. Furthermore, if PHY broadcast or broadcast-to-unicast conversion results in a branch to a terminal interface-specific node, that branch will be unneeded when all the links associated with the PHY broadcast or broadcast-to-unicast-conversion terminate at interface-specific nodes. In other words, if a first branch is associated with a virtual node that includes a needed branch to another device, then the first branch will not be pruned. As an example, if a first branch terminates at interface-specific node (without going to the device-internal node) because the device-internal will receive the broadcast message via a different interface-specific node and the first branch is associated with a broadcast node needed to reach another device, then the first branch may be pruned (trimmed) back to the previous node to remove the unneeded branch. One way to accomplish the pruning is to iteratively visit all interface-specific nodes in the network to prune unneeded branches in the routing tree.

Using the example, in FIG. 14, after initially running the modified Dijkstra's algorithm, node 641 (“d1”), node 611 (“a1”), node 612 (“a2”), node 621 (“b1”), and node 633 (“c3”) would all be included in the routing tree, because the modified Dijkstra's algorithm seeks to reach all nodes in the network graph. During the pruning operation described at block 1866 of FIG. 18, unneeded branches to node 641 (“d1”), node 611 (“a1”), node 612 (“a2”), and node 621 (“b1”) would be trimmed. For example, because device D (device-internal node 1145, “d0”) receives the broadcast traffic from node 642 (“d2”), the interface “d1” would not forward the broadcast traffic to “d0.” Therefore, the branch to interface-specific node “d1” (from node 611, “a1”) would be unneeded in the routing tree. After pruning that branch (terminating at node 641, “d1”), it may become evident that the newly remaining branch ending at node 611 (“a1”) is also unneeded and can be pruned, and so on, until all unneeded branches (from interface “b2” to “b1,” “a2,” “a1,” and “d1”, and connecting links there between) are removed from the routing tree. The branch from broadcast node 1179 that terminates at node 633 (“c3”) will not be pruned even though it terminates at an interface-specific node (without going to the device specific node “c0”), because it is part of the broadcast node 1179 which is needed for broadcast traffic to ultimately reach other device-internal nodes (e.g., device-internal node 1115 “a0” and device-internal node 1145 “d0”).

FIGS. 1-18 and the operations described herein are examples meant to aid in understanding various embodiments and should not be used to limit the scope of the claims. Embodiments may perform additional operations, fewer operations, operations in parallel or in a different order, and some operations differently. While this disclosure enumerates several embodiments, additional embodiments are considered within the scope of this disclosure.

As will be appreciated by one skilled in the art, aspects of the present disclosure may be embodied as a system, method, or computer program product. Accordingly, aspects of the present disclosure may take the form of an entirely hardware embodiment, a software embodiment (including firmware, resident software, micro-code, etc.) or an embodiment combining software and hardware aspects that may all generally be referred to herein as a “circuit,” “unit” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that may contain, or store a program for use by or in connection with an instruction execution system, apparatus, or device.

Computer program code embodied on a computer readable medium for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flow diagrams and/or block diagrams of methods, apparatus (systems) and computer program products according to embodiments of the present disclosure. It will be understood that each block of the flow diagrams and/or block diagrams, and combinations of blocks in the flow diagrams and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow diagrams and/or block diagram block or blocks.

These computer program instructions may also be stored in a computer readable medium that may direct a computer, other programmable data processing apparatus, or other devices to function in a particular manner, such that the instructions stored in the computer readable medium produce an article of manufacture including instructions which implement the function/act specified in the flow diagrams and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flow diagrams and/or block diagram block or blocks.

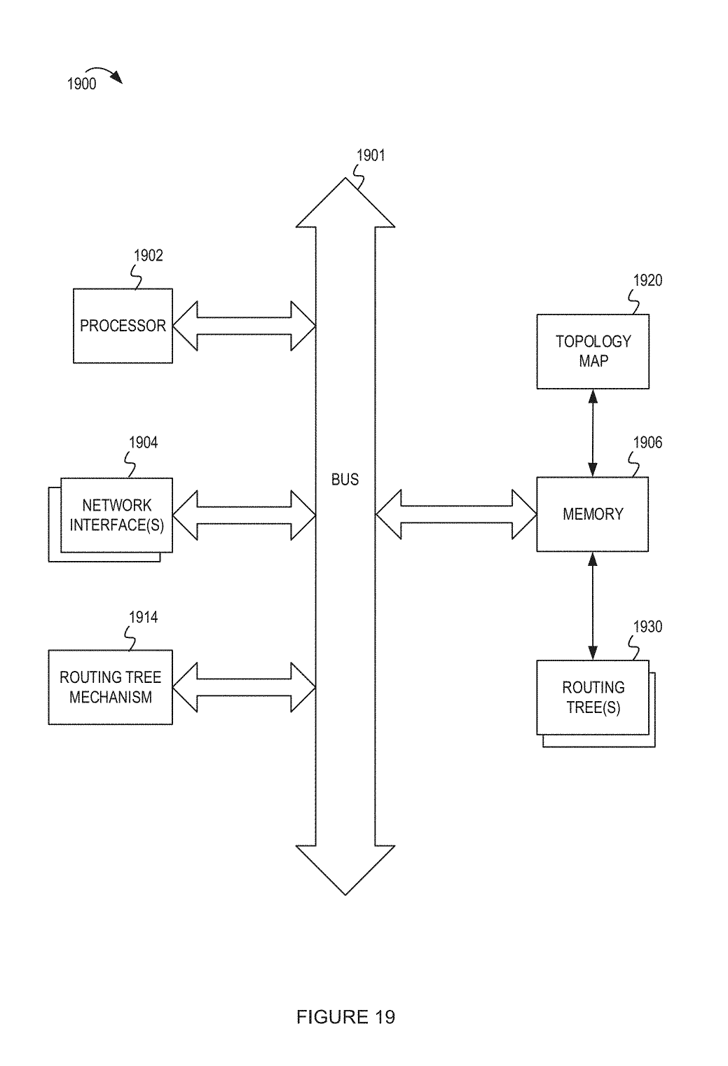

FIG. 19 is an example block diagram of one embodiment of a device 1900 capable of implementing various embodiments of this disclosure. In some implementations, the device 1900 may be hybrid device, such as any of devices 211, 221, 231, 311, 321, 331. The device 1900 includes a processor 1902 (possibly including multiple processors, multiple cores, multiple nodes, and/or implementing multi-threading, etc.). The device 1900 may include a bus 1901 (e.g., PCI, ISA, PCI-Express, HyperTransport®, InfiniBand®, NuBus, AHB, AXI, etc.). The device 1900 may include one or more network interface(s) 1904, any of which may be a wireless network interface (e.g., a WLAN interface, a Bluetooth® interface, a WiMAX interface, a ZigBee® interface, a Wireless USB interface, etc.) or a wired network interface (e.g., a powerline communication interface, an Ethernet interface, etc.). In some implementations, device 1900 may support multiple network interfaces—each of which may be configured to couple the device 1900 to a different communication medium using different network technologies.

The device 1900 includes a memory 1906. The memory 1906 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The memory 1906 may store instructions executable by the processor 1902 to implement embodiments described above. The memory 1906 may store a topology map 1920 and one or more routing tree(s) 1930. The device 1900 may include a routing tree mechanism 1914 to implement embodiments described above. The routing tree mechanism 1914 may determine the one or more routing tree(s) 1930 based, at least in part, on the topology map 1920.

Any one of these functionalities may be partially (or entirely) implemented in hardware and/or on the processor 1902. For example, the functionality may be implemented with an application specific integrated circuit, in logic implemented in the processor 1902, in a co-processor on a network interface device, etc. Further, realizations may include fewer or additional components not illustrated in FIG. 19. The processor 1902, and the memory 1906, may be coupled to the bus 1901. Although illustrated as being coupled to the bus 1901, the memory 1906 may be directly coupled to the processor 1902.

While the embodiments are described with reference to various implementations and exploitations, it will be understood that these embodiments are illustrative and that the scope of the present subject matter is not limited to them. In general, techniques for routing in a hybrid network as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the present subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the present subject matter.

What is claimed is:

1. A method for communicating via a network, the method comprising:
determining, at a first device, a topology map for the network having a plurality of devices including at least one multi-interface device, wherein the topology map includes interface-specific nodes to represent different interfaces of the at least one multi-interface device;
determining a routing tree for the network based, at least in part, on the topology map, the routing tree having a root node associated with one of the plurality of devices, wherein the routing tree defines routes from the root node to one or more destination nodes;
determining, for a frame originated from the root node, whether the first device is in a route from the root node to the one or more destination nodes based, at least in part, on the routing tree; and
forwarding the frame from the first device to the one or more destination nodes in accordance with the routing tree in response to a determination that the first device is in the route.

2. The method of claim 1, wherein determining the topology map comprises:
obtaining topology information identifying the different interfaces of the at least one multi-interface device, the topology information including a list of neighbor devices associated with each of the different interfaces.

3. The method of claim 1, wherein the topology map includes link costs between the different interfaces of the at least one multi-interface device and each neighbor device of a list of neighbor devices.

4. The method of claim 1, wherein the topology map includes either a forwarding or non-forwarding capability associated with each of the interface-specific nodes.

5. The method of claim 1, wherein determining the routing tree comprises:
determining the routing tree using a shortest path algorithm for unicast routes;
determining broadcast delivery options in the topology map;
for each broadcast delivery option:
selecting a broadcast path with a lowest path cost from the first device to a target device, and
adding the broadcast path to the routing tree as a route from the first device to the target device in response to a determination that the broadcast path has a lower total cost to reach nodes associated with the broadcast path than existing routes to those nodes and that the broadcast path does not reach a legacy device that already has a unicast route in the routing tree, and
pruning any unicast routes that terminates at one of a plurality of nodes associated with the broadcast path, wherein the unicast route is pruned to a previous node not in the plurality of nodes.

6. The method of claim 1, wherein the topology map includes a first link cost from a first node representing a first interface of the at least one multi-interface device to a second node representing a second interface of the at least one multi-interface device.

7. The method of claim 6, wherein the first link cost is nominal when the first interface and the second interface are in a same multi-interface device.

8. The method of claim 1, wherein determining the routing tree comprises:
defining a set of unvisited nodes in the topology map, the set of unvisited nodes including only nodes that have forwarding capabilities;
selecting the root node as a current node;
determining routes from the current node to neighbor nodes of the current node, wherein determining the routes comprises, for each neighbor node that has at least one link to the current node:
determining a first link from the current node to the neighbor node,
adding the first link to the routing tree as a new route from the current node to the neighbor node in response to a determination that the routing tree does not have an existing route to the neighbor node or that the new route has a lower path cost from the root node to the neighbor node than an existing route to the neighbor node, wherein the existing route is replaced by the new route, and
removing the current node from the set of unvisited nodes; and
selecting, from the set of unvisited nodes, a next node having a lowest path cost to the root node; and
repeating said determining routes using the next node as the current node.

9. The method of claim 1, further comprising:
optimizing the routing tree, wherein said optimizing includes pruning a unicast route that terminates at a particular device in response to adding a broadcast route to the routing tree that will reach the particular device.

10. The method of claim 1, wherein determining whether the first device is in the route comprises:
receiving the frame at a first interface of the first device, the frame having a source address associated with the root node and having a destination address associated with the one or more destination nodes; and
determining whether the first interface is in one of the routes of the routing tree from the root node to the one or more destination nodes.

11. The method of claim 10, further comprising:
discarding the frame based, at least in part, on a determination that the first interface of the first device is not in one of the routes of the routing tree.

12. The method of claim 1, wherein the routing tree comprises a common routing tree that is used by the plurality of devices of the network to route a frame having at least one member of the group consisting of an unknown source address, an unknown destination address, a broadcast address, and an indicator associated with routing frames with an unknown address.

13. The method of claim 12, further comprising:
sending routing information from the first device to a second device, the routing information usable by the second device to determine the common routing tree.

14. The method of claim 1, wherein the routing tree comprises a first routing tree used for unicast traffic, the method further comprising:
determining a second routing tree for the network based, at least in part, on the topology map, the second routing tree used for broadcast traffic, wherein the second routing tree includes at least one broadcast node, wherein the at least one broadcast node can represent either a physical layer (PHY) broadcast domain or a broadcast-to-unicast conversion broadcast domain.

15. The method of claim 14, wherein the second routing tree is optimized to reach each device of the plurality of devices, without regard to which interface of each device is used to reach each device, and wherein the topology map comprises a device-internal node to represent each device separately from the interface-specific nodes.

16. The method of claim 1, wherein the first device is a central coordinator for the network, the method further comprising sending the routing tree from the central coordinator to the plurality of devices.

17. The method of claim 1, further comprising:
determining a plurality of routing trees, each routing tree having a different root node that is specific to a source interface of one of the plurality of devices; and
upon receiving the frame, selecting a first routing tree of the plurality of routing trees based, at least in part, on a source address in the frame being associated with the source interface corresponding to the root node for the first routing tree; and
routing the frame in accordance with the first routing tree.

18. The method of claim 17, further comprising:
receiving the frame and determining that the frame contains an address that is not in the topology map;
selecting one of the plurality of routing trees using a common selection algorithm that is also used by other devices of the plurality of devices; and
routing the frame in accordance with the selected one of the plurality of routing trees.

19. A first device for communicating via a network, the first device comprising:
a processor; and
memory for storing instructions which, when executed by the processor, cause the first device to:
determine a topology map for the network having a plurality of devices including at least one multi-interface device, wherein the topology map includes interface-specific nodes to represent different interfaces of the at least one multi-interface device;
determine a routing tree for the network based, at least in part, on the topology map, the routing tree having a root node associated with one of the plurality of devices, wherein the routing tree defines routes from the root node to one or more destination nodes;
determine, for a frame originated from the root node, whether the first device is in a route from the root node to the one or more destination nodes based, at least in part, on the routing tree; and
forward the frame from the first device to the one or more destination nodes in accordance with the routing tree in response to a determination that the first device is in the route.

20. The first device of claim 19, wherein the instructions that cause the first device to determine whether the first device is in the route comprises instructions which, when executed by the processor, cause the first device to:
receive the frame at a first interface of the first device, the frame having a source address associated with the root node and having a destination address associated with the one or more destination nodes; and
determine whether the first interface is in one or the routes of the routing tree from the root node to the one or more destination nodes.

21. The first device of claim 20, further comprising instructions which, when executed by the processor, cause the first device to:
discard the frame based, at least in part, on a determination that the first interface of the first device is not in one of the routes of the routing tree.

22. The first device of claim 19, wherein the routing tree comprises a first routing tree used for unicast traffic, the memory storing further instructions which, when executed by the processor, cause the first device to:
determine a second routing tree for the network based, at least in part, on the topology map, the second routing tree used for broadcast traffic, wherein the second routing tree includes at least one broadcast node, wherein the at least one broadcast node can represent either a physical layer (PHY) broadcast domain or a broadcast-to-unicast conversion broadcast domain.

23. The first device of claim 19, further comprising instructions which, when executed by the processor, cause the first device to:
determine a plurality of routing trees, each routing tree having a different root node that is specific to a source interface of one of the plurality of devices; and
upon receiving the frame:
select a first routing tree of the plurality of routing trees based, at least in part, on a source address in the frame being associated with the source interface corresponding to the root node for the first routing tree; and
routing the frame in accordance with the first routing tree.

24. The first device of claim 19, further comprising:
a first interface; and
a second interface,
wherein the memory stores instructions which, when executed by the processor, cause the first device to:
independently set frame forwarding configurations for each of the first interface and the second interface based, at least in part, on the routing tree.

25. A non-transitory computer-readable medium storing instructions which, when executed by a processor of a first device, cause the first device to:
determine a topology map for a network having a plurality of devices including at least one multi-interface device, wherein the topology map includes interface-specific nodes to represent different interfaces of the at least one multi-interface device;
determine a routing tree for the network based, at least in part, on the topology map, the routing tree having a root node associated with one of the plurality of devices, wherein the routing tree defines routes from the root node to one or more destination nodes;
determine, for a frame originated from the root node, whether the first device is in a route from the root node to the one or more destination nodes based, at least in part, on the routing tree; and
forward the frame from the first device to the one or more destination nodes in accordance with the routing tree in response to a determination that the first device is in the route.

26. The non-transitory computer-readable medium of claim 25, wherein the instructions that cause the first device to determine the routing tree comprises instructions which, when executed by the processor, cause the first device to:
determine the routing tree using a shortest path routing algorithm for unicast routes; and
determine broadcast delivery options in the topology map;
for each broadcast delivery option:
select a broadcast path with a lowest path cost from the first device to a target device,
add the broadcast path to the routing tree in response to a determination that the broadcast path has a lower total cost to reach a plurality of nodes associated with the broadcast path than existing routes to the plurality of nodes and that the broadcast path does not reach a legacy device that already has a unicast route in the routing tree, and
prune any unicast routes that terminates at one of the plurality of nodes associated with the broadcast path, wherein the unicast route is pruned to a previous node not in the plurality of nodes.

27. The non-transitory computer-readable medium of claim 25, wherein the instructions that cause the first device to determine whether the first device is in the route comprises instructions which, when executed by the processor, cause the first device to: receive the frame at a first interface of the first device, the frame having a source address associated with the root node and having a destination address associated with the one or more destination nodes; and
determine whether the first interface is in one of the routes of the routing tree from the root node to the one or more destination nodes.

28. The non-transitory computer-readable medium of claim 27, wherein instructions, when executed by the processor, cause the first device to:
discard the frame based, at least in part, on a determination that the first interface of the first device is not in one of the routes of the routing tree.

29. The non-transitory computer-readable medium of claim 25, wherein the routing tree comprises a common routing tree that is used by the plurality of devices of the network.

30. The non-transitory computer-readable medium of claim 25, wherein the instructions, when executed by the processor, cause the first device to:
optimize the routing tree to minimize total path cost to reach all devices of the plurality of devices in the network, regardless of which interface is used to reach each device.
